(19) United States
(12) Patent Application Publication
(10) Pub. No.: US 2023/0320362 A1
(43) Pub. Date: Oct. 12, 2023

(54) COMPOSITION AND METHOD FOR WEED AND GRASS CONTROL

(71) Applicant: United Industries Corporation, Earth City, MO (US)

(72) Inventors: Matthew David McDermott, Clayton, MO (US); Gladys C. Curtis, Saint Peters, MO (US); Patrick Allen Long, Kirkwood, MO (US); Matthew P. Shipp, Montgomery, TX (US); Christina Lee Brown, Staunton, IL (US)

(21) Appl. No.: 18/181,781

(22) Filed: Mar. 10, 2023

Related U.S. Application Data
(60) Provisional application No. 63/318,859, filed on Mar. 11, 2022.

(51) Int. Cl. A01N 57/20; A01N 43/84; A01P 13/00; A01N 43/80; A01N 43/50

(52) U.S. Cl. CPC A01N 57/20; A01N 43/50; A01N 43/80; A01N 43/84; A01P 13/00

(57) ABSTRACT

The present disclosure provides herbicide composition for control of annual and perennial grasses and broadleaf weeds. In one example, a non-selective herbicide composition comprises: a post-emergent herbicidal active agent; and a burndown agent. In another example, a non-selective herbicide composition comprises: a post-emergent herbicidal active agent; a residual control active agent, and a burndown agent.

### CROSS-REFERENCE TO RELATED APPLICATION(S)

This application claims priority to U.S. Application No. 63/318,859, filed on Mar. 11, 2022, the disclosure of which is hereby incorporated by reference in its entirety.

### INTRODUCTION

Herbicidal compositions are useful for killing or suppressing the growth of unwanted plants such as grasses, weeds, and the like. Although there are herbicidal compositions that have good weed control efficacy, many of them do not have satisfied symptomology that provides users a fast and accurate indication of herbicidal effectiveness shortly after application. In addition, many herbicidal compositions are effective only for a relatively short period of time. It is thus desirable for herbicide compositions that present early burndown symptoms, or extend weed control efficacy, or both.

### COMPOSITION AND METHOD FOR WEED AND GRASS CONTROL

### Summary of Disclosure

In some aspects, the present disclosure provides non-selective herbicide compositions and methods based on a combination of a post-emergent herbicidal active agent and a burndown agent. The post-emergent herbicidal active agent may comprise glufosinate or a salt or derivative thereof. The glufosinate may be in a form of an enantiomeric mixture, or in a form of L-glufosinate. The burndown agent may comprise at least one of: a fatty acid compound, or an organic dication compound such as a diquat compound, or any combinations thereof. In some embodiments, the fatty acid compound is a fatty acid salt comprising: a C₆ to C₁₉, or C₇ to C₁₁, or C₈ to C₁₀ hydrocarbyl group optionally substituted with a hydroxyl or a C₁-C₅ hydrocarbyl group; and an ammonium, an alkali metal, an alkaline earth metal, or any combinations thereof. In certain embodiments, the burndown agent is selected from ammonium nonanoate, alkali nonanoate, alkaline earth nonanoate, ammonium decanoate, alkali decanoate, alkaline earth decanoate, or any combinations thereof. In some embodiments, the herbicide composition further comprises a carrier. The carrier may be selected from water, an organic solvent, a buffer solution, an emulsion, or combinations thereof.

In some embodiments, the composition has a ratio of post-emergent herbicidal active agent to the burndown agent from about 100:1 to about 1:100, from about 50:1 to about 1:50, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1.

In some example embodiments, the composition further comprises a functional ingredient selected from an additional herbicidal active ingredient, a surfactant, an emulsifier, a dispersing agent, a stabilizer, a foam-moderating agent, a preservative, an anti-freeze agents, a solubility-enhancing agent, a dye or colorant, a pH modifier, a thickening agent, a fragrance, an adjuvant, an excipient, a fertilizer, a rainfast agent, or any combinations thereof.

In some embodiments, the post-emergent herbicidal active agent has a concentration of about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition. In some embodiments, the burndown agent has a concentration of about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition.

Non-exclusive examples of the composition include a ready-to-use (RTU) solution. The RTU solution may have a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution. The RTU solution may have a concentration of the burndown agent from about 0.1 wt% to about 20 wt%, from about 0.5 wt% to about 10 wt%, from about 1 wt% to about 5 wt%, based on the total weight of the RTU solution.

In some embodiments, application of the composition to an area in need of weed control causes early burndown symptoms of weeds or undesired plants in the area. In some embodiments, application of the composition to the area causes long-term control efficacy and remains effective for at least 15 days, at least 45 days, or at least 60 days. The area may be a landscape edge, a non-crop area around farmsteads, building foundation, a shelter belt, a fencerow, a driveway, a sidewalk, a paver patio, a gravel area, an area under deck, a parking area, a walkway, and any unplanted area where no weeds are desired.

The composition is effective to control weeds and/or grasses selected from a list of common annual broadleaf weeds, common perennial broadleaf weeds, common annual grasses, common perennial grasses, or any combinations thereof.

In some aspects, the present disclosure provides a method for control of annual and perennial grasses and broadleaf weeds, wherein the method comprises applying a non-selective herbicide composition described herein to an area in need thereof, wherein the composition comprises a post-emergent herbicidal active agent and a burndown agent. In some embodiments, the method further comprises: applying a maintenance composition, the maintenance composition comprising a herbicidally active compound selected from a post-emergent herbicidal active agent, a residual control active agent, a burndown agent, or any combinations thereof. The maintenance composition may comprise glufosinate or a salt or derivative thereof. The maintenance composition may be applied at least 15 days, at least 30 days, at least 45 days, or at least 60 days, after applying the non-selective herbicide composition. In some embodiments, application of the non-selective herbicide composition causes early burndown symptoms after about 30 minutes to about 6 hours, or about 1 hour to about 3 hours.

In some aspects, the present disclosure provides non-selective herbicide composition for control of annual and perennial grasses and broadleaf weeds, comprising: a post-emergent herbicidal active agent; a residual control active agent; and a burndown agent. The post-emergent herbicidal active agent may comprise glufosinate or a salt or derivative thereof. The glufosinate may be in a form of an enantiomeric mixture, or in a form of L-glufosinate. The residual control active agent may comprise at least one of a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof. The PPO inhibitor may include acifluorfen, azafeniden, bifenox, carfentrazone-ethyl, flumioxazin, flumiclorac-pentyl, fluthiacet-methyl, fomesafen, ipfencarbazone, lactofen, oxadiargyl, oxadiazon, oxyfluorfen, pentoxazone, pyraclonil, pyraflufen-ethyl, saflufenacil, tiafenacil, or derivatives thereof, or any combinations thereof. The ALS/ALHS inhibitor may include imazapic, imazapyr, imazethapyr, or derivatives thereof, or any combinations thereof. The 4-HPPD inhibitor may include topramezone, mesotrione, or derivatives thereof, or a combination thereof. The burndown agent may comprise at least one of: a fatty acid compound, or an organic dication compound such as a diquat compound, or any combinations thereof. In some embodiments, the fatty acid compound is a fatty acid salt comprising: a C₆ to C₁₉, or C₇ to C₁₁, or C₈ to C₁₀ hydrocarbyl group optionally substituted with a hydroxyl or a C₁-C₅ hydrocarbyl group; and an ammonium, an alkali metal, an alkaline earth metal, or any combinations thereof. In certain embodiments, the burndown agent is selected from ammonium nonanoate, alkali nonanoate, alkaline earth nonanoate, ammonium decanoate, alkali decanoate, alkaline earth decanoate, or any combinations thereof. In some embodiments, the herbicide composition further comprises a carrier. The carrier may be selected from water, an organic solvent, a buffer solution, an emulsion, or combinations thereof.

In some embodiments, the composition has a weight ratio of the post-emergent herbicidal active agent to the residual control active agent from about 2,000:1 to about 1:100, from about 1,000:1 to about 1:10, from about 500:1 to about 1:1, from about 100:1 to about 1:1, from about 50:1 to about 1:1, from about 10:1 to about 1:1, from about 8:1 to about 1:1, from about 5:1 to about 1:1. In some embodiments, the composition has a weight ratio of the post-emergent herbicidal active agent to the burndown agent from about 100:1 to about 1:100, from about 50:1 to about 1:50, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1. In some embodiments, the composition has a weight ratio of the residual control active agent to the burndown agent from about 100:1 to about 1:500, from about 10:1 to about 1:200, from about 1:1 to about 1:200, from about 1:1 to about 1:150, from about 1:1 to about 1:100, from about 1:1 to about 1:60, from about 1:5 to about 1:30, from about 1:10 to about 1:200, from about 1:10 to about 150, from about 1:10 to about 1:100, from about 1:10 to about 1:50, from about 1:10 to about 1:40, from about 1:10 to about 1:30, or from about 1:15 to about 1:50, or from about 1:35 to about 1:150.

In some embodiments, the composition further comprise a functional ingredient selected from an additional herbicidal active ingredient, a surfactant, an emulsifier, a dispersing agent, a stabilizer, a foam-moderating agent, a preservative, an anti-freeze agents, a solubility-enhancing agent, a dye or pigment, a pH modifier, a thickening agent, a fragrance, an adjuvant, an excipient, a fertilizer, a rainfast agent, or any combinations thereof.

In some embodiments, the post-emergent herbicidal active agent has a concentration of about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition. In some embodiments, the residual control active agent has a concentration of about 0.001 wt% to about 10 wt%, from about 0.05 wt% to about 5 wt%, from about 0.1 wt% to about 5 wt%, from about 0.5 wt% to about 2 wt%, based on the total weight of the composition. In some embodiments, the burndown agent has a concentration of about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition.

In some embodiments, the composition is a ready-to-use (RTU) solution. The RTU solution may have a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution. The RTU solution may have a concentration of the or residual control active agent from about 0.001 wt% to about 1 wt%, from about 0.005 wt% to about 0.5 wt%, from about 0.01 wt% to about 0.05 wt%, based on the total weight of the RTU solution. The RTU solution may have a concentration of the burndown agent from about 0.1 wt% to about 20 wt%, from about 0.5 wt% to about 10 wt%, from about 1 wt% to about 5 wt%, based on the total weight of the RTU solution.

In some embodiments, a non-selective herbicide composition comprises: from about 0.01 wt% to about 20 wt% of a post-emergent herbicidal active agent selected from glufosinate or a salt or derivative thereof; from about 0.001 wt% to about 10 wt% of a residual control active agent comprising a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof; from about 0.05 wt% to about 50 wt% of a burndown agent comprising a fatty acid compound, or an organic dication compound such as diquat dibromide, or any combinations thereof; and a carrier, wherein the composition has a weight ratio of the post-emergent herbicidal active agent to the residual control active agent from about 100:1 to about 1:1, wherein the composition has a weight ratio of the post-emergent herbicidal active agent to the burndown agent from about 5:1 to about 1:5.

In some embodiments, application of the composition to an area in need of weed control causes early burndown symptoms (yellowing, wilting, browning, necrosis) of weeds or undesired plants after about 30 minutes to about 6 hours, or about 1 hour to about 3 hours. In some embodiments, application of the composition to an area in need of weed control causes long-term control efficacy and remains effective for at least 15 days, at least 45 days, at least 60 days, at least 90 days, at least 120 days, at least 150 days, at least 180 days, at least 210 days, at least 240 days, at least 270 days, at least 300 days, or at least 360 days, or 1 year (365/6 days). The area may be a landscape edge, a non-crop area around farmsteads, building foundation, a shelter belt, a fencerow, a driveway, a sidewalk, a paver patio, a gravel area, an area under deck, a parking area, a walkway, and any unplanted area where no weeds are desired.

In some embodiments, the composition is effective to control a weed or grass selected from at least one of: a common annual broadleaf weed, a common perennial broadleaf weed, a common annual grass, a common perennial grass, or any combinations thereof.

In some aspects, the present disclosure provides a method for control of annual and perennial grasses and broadleaf weeds, comprising applying a non-selective herbicide composition described herein to an area in need thereof, wherein the composition comprises a post-emergent herbicidal active agent; a residual control active agent; and a burndown agent.

In some embodiments, the method further comprises: applying a maintenance composition, the maintenance composition comprising a herbicidally active agent selected from a post-emergent herbicidal active agent, a residual control active agent, a burndown agent, or any combinations thereof. The maintenance composition may be applied at least 15 days, at least 30 days, at least 45 days, at least 60 days, at least 90 days, at least 120 days after applying the non-selective herbicide composition.

### Definitions and Interpretations of Selected Terms

As used herein, “weight percent,” “wt%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt%,” etc.

As used herein, “g” represents gram; “L” represents liter; “mg” represents “milligram (10⁻³ gram);” “mL” or “cc” represents milliliter (10⁻³ liter). One “µL” equals to one micron liter (10⁻⁶ liter). The units “mg/100g,” “mg/100mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (°C).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

As used herein, the term “hydrocarbyl” describes organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 30 carbon atoms.

As used herein, the term “substituted hydrocarbyl” describes hydrocarbyl moieties that are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, ketal, acyl, acyloxy, nitro, amino, amido, cyano, thiol, acetal, sulfoxide, ester, thioester, ether, thioether, hydroxyalkyl, urea, guanidine, amidine, phosphate, amine oxide, and quaternary ammonium salt.

As used herein, the phrase “herbicide” refers to a herbicidal active ingredient, agent, or mixture that kills or inhibits the growth of unwanted plants when applied.

As used herein, the phrase “residual control active” agent refers to a herbicidal active ingredient that confers “residual activity” after application to an area in need of weed or grass control. The residual control active may be a pre-emergent herbicide, post-emergent herbicide or have a combination of both modes of action. The “residual control active agent” may provide extended weed control efficacy and/or inhibition of weed seed germination when used alone or in combination with a weed killing agent. The residual activity may extend to at least 1 month, at least 2 months, at least 3 months, at least 4 months, at least 6 months, at least 9 months, or at least 12 months, after being applied to the area.

As used herein, the phrase “early burndown symptoms” means visible plant symptoms characteristic of the contact action of a burndown agent upon a part (e.g., a leaf) of a plant within about 0.1 to about 6 hours after applied in an effective amount alone or in combination with other ingredients to the plant. Such symptoms illustratively include necrosis, browning, yellowing, leafburn, desiccation, wilting, injury, and the like as visible evidence of herbicidal effectiveness. In the present disclosure, examples of the burndown agents include fatty acid compounds, organic dications such as diquat compounds, or any combinations thereof.

As used herein, the term “long term control” means a significant inhibition of regrowth and/or new growth for a substantially long period of time with or without the need of reapplication, which is achieved through the use of a herbicidally effective amount of the herbicide composition of the present disclosure to an area where an unwanted plant therein to be killed or controlled. The term “long term control” efficacy may extend to at least about 1 week, at least about 2 weeks, at least about 3 weeks, at least about 4 weeks, at least about 1 month, at least about 45 days, at least about 2 months, at least about 3 months, at least about 4 months, at least about 6 months at least about 9 months, or at least about 12 months after the herbicide composition is applied to the area.

As used herein, a “pre-emergent” herbicide refers to an herbicide that is designed to control weeds or unwanted plants by interfering with seedling germination and emergence. As used herein, a “post-emergent” herbicide refers to an herbicide that is designed to control weeds in the stage between the emergence of a seedling and the maturity of weeds or unwanted plants.

“Herbicidal efficacy” or “herbicidal effectiveness,” as used herein, refers to any observable measure of control of weed or grass growth, which can include one or more of the actions of (1) killing, (2) inhibiting growth, reproduction or proliferation, and (3) removing, destroying, or otherwise diminishing the occurrence and activity of weeds or grasses. The herbicidal effectiveness data set forth herein report “control” as a percentage following a standard procedure in the art which reflects a visual assessment of plant mortality and growth reduction by comparison with untreated plants, made by technicians specially trained to make and record such observations. In all cases, a single technician makes all assessments of percent control within any one experiment or trial.

As used herein, “glufosinate” or its salt refers to a herbicidal active ingredient which belongs to a class of glutamine synthase inhibitor. In the present disclosure, glufosinate or its salt includes enantiomers and racemate. Typically, racemic glufosinate and glufosinate-P (L-glufosinate) are included. Examples of glufosinate salts which can be used for the present disclosure include glufosinate-ammonium, glufosinate-P-ammonium, glufosinate-sodium, and glufosinate-P-sodium. The preferable glufosinate salt is glufosinate-ammonium.

As used herein, protoporphyrinogen oxidase (PPO) inhibitor refers a herbicidal active ingredient known as protoporphyrinogen oxidase inhibitor and is available from commercial sources. Example of the PPO inhibitors which can be used for the present invention include saflufenacil, trifludimoxazin, flumioxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy] acetate, sulfentrazone, lactofen, fomesafen or its salts, flumiclorac-pentyl, carfentrazone-ethyl, fluthiacet-methyl, tiafenacil, pyraflufen ethyl, azafenidin, oxadiazone, oxadiargyl, cinidon-ethyl, pyraclonil, cyclopyranil, flufenpyr-ethyl, butafenacil, fluazolate, pentoxazone, oxyfluorfen, acifluorfen or its salt, aclonifen, bifenox, fluoroglycofen-ethyl. Preferable PPO inhibitors are flumioxazin, saflufenacil, and trifludimoxazin.

As used herein, 4-hydroxyphenylpyruvate dioxygenase (HPPD) inhibitor refer to a class of herbicides that prevent growth in plants by blocking 4-Hydroxyphenylpyruvate dioxygenase, an enzyme in plants that breaks down the amino acid tyrosine into molecules that are then used by plants to create other molecules that plants need. Non-limiting examples of HPPD inhibitors include pyrazolones such as pyrazolate, pyrazoxyfen, benzofenap, pyrasulfotole; triketones such as sulcotrione, mesotrione, topramezone, benzobicyclon, tembotrione; and diketonitriles such as isoxaflutole.

As used herein, acetolactate synthase/acetohydroxy acid synthase (ALS/AHAS) inhibitor refers to a class of herbicides that prevent growth in plants by blocking acetolactate synthase, a key enzyme in the pathway of biosynthesis of the branched-chain amino acids isoleucine, leucine, and valine. Plant deaths result from events occurring in response to inhibition of branched-chain amino acids. Non-limiting examples of ALS/AHAS inhibitor include imidazolinones, pyrimidinylthiobenzoates, sulfonylaminocarbonyltriazolinones, sulfonylureas, triazolopyrimidines. imazapic, imazapyr, imazethapyr, and derivatives thereof.

As used herein, the term “broadleaf weeds” refers to any variety of broadleaf weeds commonly found in lawn or turf, including but not limited to common dandelion, clover, chickweed, plantain, spurge, hendit, ground ivy, wild garlic, wild onion, wild violet and black medic. Non-limiting examples of broadleaf weeds include Ragweed, Buckhorn plantain, Mustard, Lambsquarters, Black nightshade, Clover, Horseweed®, Palmer pigweed®, Eclipta, Bittercress, Henbit, Common groundsel, Velvetleaf, Shepherd’s purse, Hairy galinsoga, New Zealand moss, Marsh watercress, Flexuous bittercress, Common yellow oxalis.

As used herein, the term “annual grasses” refers to a class of grasses that complete their life cycle, from germination to the production of seeds, within one growing season, and then die. The term “perennial grasses” refers to a class of grasses that live more than two years. Non-limiting examples of annual and perennial grasses include Crabgrass, Bluegrass, Barnyardgrass, Late watergrass®, Canarygrass, Bearded Sprangletop, Bristlegrass/Foxtail, and Fall Panicum.

### BRIEF DESCRIPTION OF THE DRAWINGS

FIG. 1A shows the field experiments results of tested herbicide compositions Examples 1-5 and Comparative Example 1 for the control of Crimson Clover, an annual broadleaf weed.

FIG. 1B shows the field experiments results of tested herbicide compositions Examples 1-5 and Comparative Example 1 for the control of Annual Rye Grass, an annual grass.

FIG. 1C shows the field experiments results of tested herbicide compositions Examples 1-5 and Comparative Example 1 for the control of Burclover, an annual broadleaf weed.

FIG. 1D shows the field experiments results of tested herbicide compositions Examples 2-4 and Comparative Example 1 for the control of Common Dandelion, a perennial broadleaf weed.

FIG. 1E shows the field experiments results of tested herbicide compositions Examples 2-4 and Comparative Example 1 for the control of Water Pennywort, a perennial broadleaf weed.

FIG. 2A shows the early burndown efficiency for Examples 4 and 22 for the control of Dallisgrass, a perennial grass.

FIG. 2B shows the early burndown efficiency for Examples 4 and 22 for the control of Torpedograss, a perennial grass.

FIG. 2C shows the early burndown efficiency for Examples 4 and 22 for the control of Bermuda Grass, a perennial grass.

FIG. 2D shows the early burndown efficiency for Examples 4 and 22 for the control of Sprawling Horseweed, a perennial broadleaf weed.

FIG. 2E shows the early burndown efficiency for Examples 4 and 22 for the control of White Clover, a perennial broadleaf weed.

FIG. 2F shows the early burndown efficiency for Examples 4 and 22 for the control of Common Lespedeza, an annual broadleaf weed.

FIG. 2G shows the early burndown efficiency for Examples 4 and 22 for the control of King Ranch Bluestem, a perennial grass.

FIG. 2H shows the early burndown efficiency for Examples 4 and 22 for the control of Virginia Buttonweed, a perennial broadleaf weed.

FIG. 2I shows the early burndown efficiency for Examples 4 and 22 for the control of Matchweed, a perennial broadleaf weed.

FIG. 3A shows the field experiments results of tested herbicide compositions Examples 7-9 and Comparative Example 1 for the control of Crimson Clover, an annual broad leaf weed.

FIG. 3B shows the field experiments results of tested herbicide compositions Examples 7-9 and Comparative Example 1 for the control of Annual Rye Grass, an annual grass.

FIG. 3C shows the field experiments results of tested herbicide Examples 7-9 and Comparative Example 1 for the control of Rescue Grass, an annual grass.

FIG. 4A shows the early burndown efficiency of tested herbicide compositions Examples 10-18 for the control of Common Lespedeza, an annual broad leaf weed.

FIG. 4B shows the early burndown efficiency of tested herbicide compositions Examples 10-18 for the control of Common Carpetgrass, a perennial grass.

FIG. 4C shows the early burndown efficiency of tested herbicide compositions Examples 10-18 for the control of Common Bermuda Grass, a perennial grass.

FIG. 4D shows the early burndown efficiency of tested herbicide compositions Examples 10-18 for the control of King Ranch Bluestem, a perennial grass.

FIG. 4E shows the early burndown efficiency of tested herbicide compositions Examples 10-18 for the control of Water Couch, a broadleaf.

FIG. 5A shows the herbicidal efficacy of tested herbicide compositions Examples 10-18 for the control of Common Lespedeza, an annual broad leaf weed.

FIG. 5B shows the herbicidal efficacy of tested herbicide compositions Examples 10-18 for the control of Common Carpetgrass, a perennial grass.

FIG. 5C shows the herbicidal efficacy of tested herbicide compositions Examples 10-18 for the control of Common Bermuda Grass, a perennial grass.

FIG. 5D shows the herbicidal efficacy of tested herbicide compositions Examples 10-18 for the control of King Ranch Bluestem, a perennial grass.

FIG. 5E shows the herbicidal efficacy of tested herbicide compositions Examples 10-18 for the control of Water Couch, a perennial grass.

FIG. 6A shows the residual control efficacy (% of weed-free area of the plot) of tested herbicide compositions Examples 10-18 on the King Ranch Bluestem plot.

FIG. 6B shows the residual control efficacy (% of weed free area of the plot) of tested herbicide compositions Examples 10-18 on the Water Couch plot.

FIG. 6C show the residual control efficacy (% of weed free are of the plot) of tested herbicide compositions Examples 10-18 on the Common Carpetgrass plot.

FIG. 7A shows the herbicidal efficacy (% control extended to 45 days after application) of tested herbicide compositions Examples 19-21 and Comparative Examples 1-2 for the control of Common Lespedeza, an annual broadleaf weed.

FIG. 7B shows the herbicidal efficacy (% control extended to 45 days after application) of tested herbicide compositions Examples 19-21 and Comparative Examples 1-2 for the control of King Ranch Bluestem, a perennial grass.

FIG. 7C shows the herbicidal efficacy (% control extended to 45 days after application) of tested herbicide compositions Examples 19-21 and Comparative Examples 1-2 for the control of St. Augustine Grass, a perennial grass.

FIG. 7D shows the herbicidal efficacy (% control extended to 45 days after application) of tested herbicide compositions Examples 19-21 and Comparative Examples 1-2 for the control of Pensacola Bahiagrass, a perennial grass.

FIG. 8A shows the herbicidal efficacy (% control extended to 90 days after application) of tested herbicide compositions Examples 19-21 and Comparative Examples 1-2 for the control of Common Bermuda Grass, a perennial grass.

FIG. 8B shows the herbicidal efficacy (% control extended to 90 days after application) of tested herbicide compositions Examples 19-21 and Comparative Examples 1-2 for the control of Dalisgrass, a perennial grass.

FIG. 8C shows the herbicidal efficacy (% control extended to 90 days after application) of tested herbicide compositions Examples 19-21 and Comparative Examples 1-2 for the control of Sprawling Horseweed, a perennial broadleaf weed.

FIG. 8D shows the herbicidal efficacy (% control extended to 90 days after application) of tested herbicide compositions Examples 19-21 and Comparative Examples 1-2 for the control of Smooth Crabgrass, an annual grass.

### DETAILED DESCRIPTION

The present disclosure relates to herbicide compositions and methods. In particular, the present disclosure provides herbicide compositions having specific combinations of herbicidal active ingredients and treatments using such compositions to cause early burndown symptoms of unwanted plants, residual activity, and/or long-term control efficacy.

In a first aspect, the present disclosure is related to non-selective herbicide compositions, methods or treatments for weed/grass control. The herbicide composition may be used for control of annual and perennial grasses and broadleaf weeds. In one example, a non-selective herbicide composition comprises a post-emergent herbicidal active agent and a burndown agent. The herbicide compositions may be solids, such as, for example, dusts, granules, water-dispersible granules, or wettable powders; or liquids, such as, for example, emulsifiable concentrates, solutions, emulsions or suspensions. They can also be provided as a pre-mix or tank mixed. In some embodiments, the herbicide composition is a liquid or aqueous concentrate. In other embodiments, the herbicide composition is a ready-to-use (RTU) composition, particularly, a sprayable herbicide RTU composition.

In some embodiments, the post-emergent herbicidal active agent comprises glufosinate or a salt or derivative thereof. Glufosinate or its salt is a herbicidal active agent which belongs to a class of Glutamine synthase inhibitor. In the present disclosure, glufosinate or its salt includes enantiomers and racemate. Typically, racemic glufosinate and glufosinate-P (L-glufosinate) are included. Examples of glufosinate salts which can be used for the present disclosure include glufosinate-ammonium, glufosinate-P-ammonium, glufosinate-sodium, and glufosinate-P-sodium. A preferable glufosinate salt is glufosinate-ammonium.

In particular embodiments, the post-emergent herbicidal active agent comprises a L-glufosinate. L-Glufosinate, also called glufosinate-P, is (2S)-2-amino-4-[hydroxy(methyl)phosphinoyl]butyric acid (CAS Reg. No. 35597-44-5). Relevant salts of L-glufosinate are L-glufosinate-ammonium (also called glufosinate-P-ammonium), which is ammonium (2S)-2-amino-4-(methylphosphinato) butyric acid (CAS Reg. No. 73777-50-1); L-glufosinate-sodium (also called glufosinate-P- sodium), which is sodium (2S)-2-amino-4-(methylphosphinato)butyric acid (CAS Reg. No. 70033-13-5) and L-glufosinate-potassium (also called glufosinate-P-potassium), which is potassium (2S)-2-amino-4-(methylphosphinato)butyric acid. L-Glufosinate as used in the present disclosure may comprise more than 70% by weight of the glufosinate enantiomers; or more than 80% by weight of the glufosinate enantiomers; or more than 90% of the glufosinate enantiomers, or more than 95% of the glufosinate enantiomers. L-glufosinate may be prepared according to methods known in the art, e.g. as described in WO2006/104120, US5530142, EP0127429 and J. Chem. Soc. Perkin Trans. 1, 1992, 1525-1529.

In some embodiments, the burndown agent as used herein comprises at least one of: a fatty acid compound, or an organic dication compound, or any combinations thereof. The burndown agent provides users a quick, accurate, and reliable visual indication of the effectiveness of the herbicide composition after application. It was surprisingly found the combination of post-emergent herbicidal active agent, particular glufosinate, and the burndown agent, form a compatible, stable, and effective composition that advantageously provides users with both long-term efficacy of weed control as well as early burndown symptoms of weeds. It is noted that the specific concentrations of post-emergent herbicidal active agent, the burndown agents, as well as the relative weight ratio of these constituting components according to the present disclosure are important to demonstrate an enhanced effect on weed and/or grass control.

In some embodiments, the burndown agent comprises a fatty acid compound. In particular embodiments, the fatty acid compound is a fatty acid salt having the following formula (I):

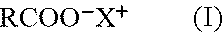

wherein, R is a C₆ to C₁₉, or C₇ to C₁₁, or C₈ to C₁₀ hydrocarbyl group optionally substituted with a hydroxyl or a C₁-C₅ hydrocarbyl group; and X is an ammonium, an alkali metal, an alkaline earth metal, or any combinations thereof.

Non-limiting examples of the fatty acid salt includes Enanthic acid (CH₃(CH₂)₅COO⁻X⁺), Capric acid salt (CH₃(CH₂)₆COO⁻X⁺), Pelargonic acid or nonanoic acid salt (CH₃(CH₂)₇COO⁻X⁺), Capric acid or decanoic acid salt (CH₃(CH₂)₈COO⁻X⁺), Undecylic acid salt (CH₃(CH₂)₉COO⁻X⁺), Lauric acid (CH₃(CH₂)₁₀COO⁻X⁺), Tridecylic acid salt (CH₃(CH₂)₁₁COO⁻X⁺), Myristic acid (CH₃(CH₂)₁₂COO⁻X⁺), Hexadecanoic acid (Palmitic acid) salt (CH₃(CH₂)₁₄COO⁻X⁺), Stearic acid salt (CH₃(CH₂)₁₆COO⁻X⁺), Oleic acid salt (CH₃(CH₂)₄CH=CHCH₂CH=CH(CH₂)₇COO⁻X⁺), or any combinations thereof.

In some embodiments, the burndown agent used herein is in a form of or derived from a fatty acid or fatty acid salt composition, such as cocoate, which is known as a mixture of free fatty acids derived from a “cracking” of coconut oil. A typical example of cocoate comprises C₆ to C₁₉ saturated or unsaturated fatty acids and/or salt thereof.

In particular embodiments, the fatty acid compound is at least one of: ammonium nonanoate, alkali nonanoate, alkaline earth nonanoate, ammonium decanoate, alkali decanoate, alkaline earth decanoate, ammonium cocoate, alkali cocoate, alkaline cocoate, or any combinations thereof. In certain embodiments, the fatty acid is ammonium nonanoate.

In some embodiments, the burndown agent comprises a dication compound. A non-limiting example of the dication compound is a diquat salt such as diquat dibromide or diquat dichloride.

In certain embodiments, the burndown agent is a fatty acid and a dication compound. In certain embodiments, the burndown agent comprises a fatty acid compound and is free or substantially free from a dication compound. In certain embodiments, the burndown agent comprises a dication compound and is free or substantially free from a fatty acid compound.

In some embodiments, the composition has a ratio of post-emergent herbicidal active agent to the burndown agent from about 100:1 to about 1:100, from about 50:1 to about 1:50, from about 20:1 to about 1:20, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1. In some embodiments, the ratio of post-emergent herbicidal active agent to the burndown agent is at least about 1:100, at least about 1:50, at least about 1:20, at least about 1:10, at least about 1:8, at least about 1:6, at least about 1:4, at least about 1:2, or at least about 1:1. In some embodiments, the ratio of post-emergent herbicidal active agent to the burndown agent is at most 100:1, at most about 50:1, at most about 20:1, at most about 10:1, at most about 1:1, at most about 1:2, at most about 1:4, at most about 1:6, at most about 1:8, at most about 1:10, at most about 1:20, at most about 1:50, or at most about 1:100.

In certain embodiments, the ratio of post-emergent herbicidal active agent to the burndown agent is from about 1:7 to about 1:1, from about 1:6 to about 1:1, from about 1:5 to about 1:1, from about 1:4 to about 1:1, from about 1:3 to about 1:1, or from about 1:2 to about 1:1.

In some embodiments, the present herbicide composition further comprises a carrier. The carrier may be liquid or solid. Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller’s earth, cottonseed hulls, wheat flour, soybean flour, pumice, wood flour, walnut shell flour, lignin, cellulose, and the like.

In some embodiments, the present herbicide composition optionally comprises a functional ingredient. Non-limiting examples of the functional ingredient include an additional herbicidal active ingredient, a surfactant (surface-active agent), an emulsifier, a dispersing agent, a stabilizer, a foam-moderating agent, a preservative, an anti-freeze agents, a solubility-enhancing agent, a dye or colorant, a pH modifier, a thickening agent, an agriculturally acceptable fragrance, an agriculturally acceptable adjuvant, an agriculturally acceptable excipient, a fertilizer, a rainfast agent, or any combinations thereof.

In some embodiments, the surface-active agents described herein are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; poly-ethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters. In some embodiments, the herbicide composition has a concentration of the surfactant (or surface active agent) from about 0.01 wt% to about 10 wt%, or from about 0.1 wt% to about 8 wt%, from about 0.5 wt% to about 5 wt%, or from about 1 wt% to about 3 wt%, based on the total weight of the herbicide composition.

In some embodiments, the post-emergent herbicidal active agent has a concentration from about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition. In certain embodiments, the present composition is a liquid herbicide concentrate and has a concentration of the post-emergent herbicidal active agent from about 1 wt% to about 20 wt %, or from about 1 wt% to about 10 wt%, or from about 1 wt % to about 8 wt%, or from about 1 wt% to about 6 wt%, or from about 1 wt% to about 4 wt%, or from about 1 wt% to about 2 wt%, based on the total weight of the herbicide concentrate.

In some embodiments, the burndown agent has a concentration from about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition. In certain embodiments, the present composition is a liquid herbicide concentrate and has a concentration of the burndown agent from about 1 wt% to about 40 wt %, or from about 1 wt% to about 30 wt%, or from about 1 wt % to about 20 wt%, or from about 1 wt% to about 10 wt%, or from about 1 wt% to about 5 wt%, based on the total weight of the herbicide concentrate.

In some embodiments, the present composition is a RTU herbicide composition. The RTU composition can be made by dilution of a herbicide concentrate described herein or by dilution of each constituting component separately followed by a combination of the diluted components. In some embodiments, the RTU composition has a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution. In some embodiments, the RTU solution has a concentration of the burndown agent from about 0.1 wt% to about 20 wt%, from about 0.5 wt% to about 10 wt%, from about 1 wt% to about 5 wt%, based on the total weight of the RTU solution.

In particular embodiments, a non-selective herbicide composition comprises: from about 0.01 wt% to about 20 wt% of a post-emergent herbicidal active agent selected from glufosinate or a salt or derivative thereof; from about 0.05 wt% to about 50 wt% of a burndown agent comprising a fatty acid compound, or an organic dication compound such as diquat dibromide, or any combinations thereof; and a carrier, wherein the composition has a weight ratio of the post-emergent herbicidal active agent to the burndown agent from about 200:1 to 1:200. In certain embodiments, the burndown agent is selected from ammonium nonanoate, alkali nonanoate, alkaline earth nonanoate, a diquat compound, or any combinations thereof.

In particular embodiments, a non-selective herbicide RTU composition comprises: from about 0.1 wt% to about 0.5 wt% of glufosinate or a salt or derivative thereof; from about 1 wt% to about 5 wt% of a burndown agent selected from ammonium nonanoate, a diquat compound, or both; and water, wherein the composition has a weight ratio of glufosinate to the burndown agent from about 10:1 to about 1:10, or from about 1:10 to about 1:1, or from about 1:7 to about 1:1, or from about 1:5 to about 1:1.

In particular embodiments, a non-selective herbicide RTU composition comprises: from about 0.1 wt% to about 0.5 wt% of glufosinate or a salt or derivative thereof; from about 1 wt% to about 5 wt% of ammonium nonanoate; and water, wherein the RTU composition has a weight ratio of glufosinate to the ammonium nonanoate from about 1:7 to about 1:1.

In particular embodiments, a non-selective herbicide RTU composition comprises: from about 0.1 wt% to about 0.5 wt% of glufosinate or a salt or derivative thereof; from about 1 wt% to about 5 wt% of a diquat compound; and water, wherein the RTU composition has a weight ratio of glufosinate to the diquat compound of about 1:1 to about 1:100, or from about 1:1 to about 1:20, or from about 1:1 to about 1:10.

In the practice of the present teachings, the pH of the herbicidal composition is preferably controlled in order to obtain a storage stable formulation and one that effectively provides the desired fast developing symptomology. More particularly, in some embodiments, the final pH of the herbicidal composition is controlled in the range of from about 2 to about 10, or from about 4 to about 9, or from about 6 to about 8. If the pH of the final composition is beyond such pH range, the burndown agents may tend to separate from the composition upon standing and it may be necessary for the user to shake or agitate the composition to obtain a uniform solution to spray. In some embodiments, the herbicide composition or RTU composition according to the present disclosure has a pH from about 6.0 to about 9.0, or from about 6.4 to about 7.8, or from about 6.8 to about 7.4, or from about 6.8 to about 7.0. In certain embodiments, the final pH of the RTU composition is controlled in the range of from about 7.1 to about 7.6, from 7.2 to about 7.5, from about 7.25 to about 7.4, or at about 7.3.

If pH adjustment is necessary, it is readily achieved by the addition of pH adjusting base or acidic component (or pH modifier or the like) during the formulation preparation process. Suitable bases for pH adjustment include those providing hydroxide in water, or an amine or alkali metal or alkaline earth metal hydroxide, or potassium hydroxide.

The herbicidal compositions (concentrates or RTU compositions) of the present disclosure may be readily prepared by simple mixing of the various components and optional ingredients in the desired quantities using a stirrer or any other suitable container or device producing the necessary amount of agitation or circulation to thoroughly mix the ingredients. In one example, an herbicidal RTU composition may be formulated by first adding/dissolving/diluting/mixing the source of burndown agent or other optional functional ingredients in a carrier such as water or a buffer or an pre-formed emulsion, adding the source of glufosinate component and optional surfactant component, followed by addition of the source of pH modifier or other suitable adjuvants. In some embodiments, a solution of glufosinate or a salt thereof is made by dissolution, and the glufosinate solution is combined with other ingredient or intermediate solutions to from the herbicide composition. In alternative embodiments, a killed artisan would appreciate the criticality of stepwise addition of various ingredients in a particular sequence to achieve a final stable herbicidal composition according to the present disclosure.

The compositions of the present disclosure can be readily used as prepared or further diluted in a carrier such as water by a user in a spray container prior to use, although those of skill in the art will recognize that the dilution will have a practical dilution limit set by efficacy.

Suitable herbicidally efficacious application rates of the present compositions will vary depending on concentration of the composition and/or the target plant species, weather, climate, and geography. The spray volume is in the range from about 10 to about 1,000 gallons per acre (gpa), or from about 50 to about 500 gpa, or from about 100 to about 250 gpa.

The present compositions when applied to an area in need of weed control cause early burndown symptoms of weeds or undesired plants in the area or induce early appearance of visual phytotoxic effects in treated plants. It is noted that the present compositions having a combination of the post-emergent herbicide active agent, the residual control active agent, and the burndown agent are demonstrated to have the early burndown effect leaving the long term control weed efficacy provided by the post-emergent herbicide active agent. Particularly, in some embodiments, the present compositions, e.g., based on the combination of glufosinate or salt or derivative thereof and the fatty acid compound, or the combination of glufosinate or salt or derivative thereof and the diquat compound, or the combination of glufosinate or salt or derivative thereof and both the fatty acid compound and the diquat compound, present both early burndown symptoms of the treated plants and an enhanced effect on weed control, as compared with the control compositions.

In some examples, the present disclosure also provides methods for killing, or controlling, or inhibiting, or otherwise reducing growth of weeds or grasses in an area in need thereof. In one example, a method for control of annual and perennial grasses and broadleaf weeds comprises: treating an area in need of weed control with any herbicide composition described herein. The treatment comprises applying a herbicidally effective amount of the herbicide composition to the area. In some embodiments, the treatment comprises spraying a herbicidally effective amount of the herbicide composition stored in a spray container to the area. The compositions can be sprayed onto the surface of the area, or soil therein, or any location where undesired weeds or grasses grow or will grow therein. The compositions sprayed onto the area may or may not be in contact with the weeds or grasses. In some embodiments, the compositions are sprayed onto foliage of the weeds or grasses.

The herbicidal sprayable RTU compositions included in the present disclosure can be applied to the foliage of the plants to be treated through any of the appropriate methods that are well known to those having skill in the art. In one embodiment, the RTU composition is packaged in a portable container suitable for hand carry by the user and fitted with an apparatus for manually releasing the composition from the container onto the foliage of the plants to be treated in the form of a spray.

The area to be treated may be a residential, industrial, or commercial area, including but not limited to landscape edge, a non-crop area around farmsteads, building foundation, a shelter belt, a fencerow, a driveway, a sidewalk, a paver patio, a gravel area, an area under deck, a parking area, a walkway, a garden, a lawn, and any unplanted area where no weeds are desired. In particular embodiments, the area is a residential area.

In some embodiments, treatment of the area causes early burndown or injury symptoms of weeds or undesired plants, such as yellowing, wilting, browning, necrosis, after about 15 minutes to about 6 hours, or about 30 minutes to about 4 hours, or about 1 hour to about 3 hours.

In some embodiments, treatment of the area causes at least about 10% weed/grass control within about 3 hours after application of the composition, at least about 15% weed/grass control within about 6 hours after application of the composition, at least about 30% weed/grass control within about 24 hours after application of the composition, at least about 70% weed/grass control within about 7 days after application of the composition, at least about 90% weed/grass control within about 21 days after application of the composition.

In some embodiments, treatment of the area causes long-term control efficacy and remains effective for at least 15 days, at least 45 days, at least 60 days, after application of the composition without reapplication. In certain embodiments, the herbicidal efficacy remains at least about 80%, at least about 85%, at least about 90%, at least about 95%, at least about 96%, at least about 97%, at least about 98%, at least about 99%, or at least about 100% weed/grass control of the treated area for a period of time of at least about 1 week, at least about 2 weeks, at least about 3 weeks, at least about 4 weeks, at least about 5 weeks, at least about 6 weeks, at least about 7 weeks, at least about 8 weeks, at least about 9 weeks, or at least about 10 weeks after application of the composition.

In some embodiments, the present method further comprises: applying a maintenance composition. The maintenance composition may comprise a herbicidally active ingredient selected from a post-emergent herbicidal active agent, a residual control active agent, a burndown agent, as described in the present disclosure, or any combinations thereof. The maintenance composition may be used to further improve the herbicidal efficacy, or maintain the herbicidal efficacy for an extended period of time, or both. In certain embodiments, the maintenance composition is the same or substantially same as the herbicidal composition that has been applied. In certain embodiments, the maintenance composition is a commercially available herbicide composition. In certain embodiments, the maintenance composition comprises from about 0.05 wt% to about 20 wt% of glufosinate or salt or derivative thereof.

The maintenance composition may be applied at least about 15 days, at least about 30 days, at least about 45 days, or at least about 60 days after applying the herbicide composition. In some embodiments, the method comprises applying the maintenance composition multiple times sequentially or in a coordinated fashion with the herbicide composition of the present disclosure.

Application of the maintenance composition may cause a longer term control efficacy of the treated area and may maintain the efficacy of the applied herbicide composition for a total of at least 15 days, at least 45 days, at least 60 days, at least 90 days, at least 120 days, at least 150 days, at least 180 days, at least 210 days, at least 240 days, at least 270 days, at least 300 days, at least 330 days, or at least 360 days, or 1 year (365/6 days) after the application of the herbicide composition.

The present methods are further described in the following embodiments. In some particular embodiments, a method for control of annual and perennial grasses and broadleaf weeds, comprising applying a non-selective herbicide composition, the herbicide composition comprising: from about 0.01 wt% to about 20 wt% of a post-emergent herbicidal active agent selected from glufosinate or a salt or derivative thereof; from about 0.05 wt% to about 50 wt% of a burndown agent comprising a fatty acid compound, or an organic dication compound such as diquat dibromide, or any combinations thereof; and a carrier, wherein the herbicide composition has a weight ratio of the post-emergent herbicidal active agent to the burndown agent from about 200:1 to about 1:200.

In some particular embodiments, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 1 wt% to about 5 wt% of a burndown agent selected from ammonium nonanoate, a diquat compound, or both; and water, wherein the RTU composition has a weight ratio of glufosinate to the burndown agent of about 200:1 to about 1:200.

In some particular embodiments, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 1 wt% to about 5 wt% of ammonium nonanoate; and water, wherein the RTU composition has a weight ratio of glufosinate to the ammonium nonanoate of about 1:10 to about 1:100.

In some particular embodiments, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 1 wt% to about 5 wt% of a diquat compound; and water, wherein the RTU composition has a weight ratio of glufosinate to the diquat compound of about 1:1 to about 1:100, or from about 1:1 to about 1:20, or from about 1:1 to about 1:10.

In some particular embodiments, a method for control of annual and perennial grasses and broadleaf weeds, comprising: (1) applying a non-selective herbicide RTU composition, the RTU composition comprising: from about 0.1 wt% to about 0.5 wt% of glufosinate or a salt or derivative thereof; from about 1 wt% to about 5 wt% of a burndown agent selected from a fatty acid compound or a diquat compound or both; and water, wherein the composition has a weight ratio of glufosinate to the diquat compound of about 1:1 to about 1:100, or from about 1:1 to about 1:20, or from about 1:1 to about 1:10; and (2) applying a maintenance composition, the maintenance composition comprising from about 0.1 wt% to about 0.5 wt% of glufosinate or a salt or derivative thereof.

In a second aspect, the present disclosure is related to non-selective herbicide compositions, methods or treatments for weed/grass control. The herbicide composition may be used for control of annual and perennial grasses and broadleaf weeds. In one example, a non-selective herbicide composition comprises a post-emergent herbicidal active agent, a residual active control agent, and a burndown agent. The herbicide compositions may be solids, such as, for example, dusts, granules, water-dispersible granules, or wettable powders, or liquids, such as, for example, emulsifiable concentrates, solutions, emulsions or suspensions. They can also be provided as a pre-mix or tank mixed. In some embodiments, the herbicide composition is a liquid or aqueous concentrate. In other embodiments, the herbicide composition is a ready-to-use (RTU) composition, particularly, a sprayable herbicide RTU composition.

In some embodiments, the post-emergent herbicidal active agent comprises glufosinate or a salt or derivative thereof. Glufosinate or its salt is a herbicidal active agent which belongs to a class of Glutamine synthase inhibitor. In the present disclosure, glufosinate or its salt includes enantiomers and racemate. Typically, racemic glufosinate and glufosinate-P (L-glufosinate) are included. Examples of glufosinate salts which can be used for the present disclosure include glufosinate-ammonium, glufosinate-P-ammonium, glufosinate-sodium, and glufosinate-P-sodium. A preferable glufosinate salt is glufosinate-ammonium.

In particular embodiments, the post-emergent herbicidal active agent comprises a L-glufosinate. L-Glufosinate, also called glufosinate-P, is (2S)-2-amino-4-[hydroxy(methyl)phosphinoyl]butyric acid (CAS Reg. No. 35597-44-5). Relevant salts of L-glufosinate are L-glufosinate-ammonium (also called glufosinate-P-ammonium), which is ammonium (2S)-2-amino-4-(methylphosphinato) butyric acid (CAS Reg. No. 73777-50-1); L-glufosinate-sodium (also called glufosinate-P-sodium), which is sodium (2S)-2-amino-4-(methylphosphinato)butyric acid (CAS Reg. No. 70033-13-5) and L-glufosinate-potassium (also called glufosinate-P-potassium), which is potassium (2S)-2-amino-4-(methylphosphinato)butyric acid. L-Glufosinate as used in the present disclosure may comprise more than 70% by weight of the glufosinate enantiomers; or more than 80% by weight of the glufosinate enantiomers; or more than 90% of the glufosinate enantiomers, or more than 95% of the glufosinate enantiomers. L-glufosinate may be prepared according to methods known in the art, e.g. as described in WO2006/104120, US5530142, EP0127429 and J. Chem. Soc. Perkin Trans. 1, 1992, 1525-1529.

In some embodiments, the residual control active agent comprises at least one of: a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof.

In particular embodiments, the PPO inhibitor comprises at least one of: acifluorfen, azafeniden, bifenox, carfentrazone-ethyl, flumioxazin, flumiclorac-pentyl, fluthiacet-methyl, fomesafen, ipfencarbazone, lactofen, oxadiargyl, oxadiazon, oxyfluorfen, pentoxazone, pyraclonil, pyraflufen-ethyl, saflufenacil, tiafenacil, or derivatives thereof, or any combinations thereof. In particular embodiments, the ALS/ALHS inhibitor comprises at least one of: imazapic, imazapyr, imazethapyr, or derivatives thereof, or any combinations thereof. In particular embodiments, the 4-HPPD inhibitor comprises at least one of: topramezone, mesotrione, or derivatives thereof, or a combination thereof.

In certain embodiments, the residual control active agent is selected from the group consisting of: flumioxazin, imazapic, imazapyr, imazethapyr, topramezone, mesotrione, or derivatives thereof, or any combinations thereof. In certain embodiments, the residual control active agent is flumioxazin or derivative thereof.

In some embodiments, the burndown agent as used herein comprises at least one of: a fatty acid compound, or an organic dication compound, or any combinations thereof. The burndown agent provides users a quick, accurate, and reliable visual indication of the effectiveness of the herbicide composition after application. It was surprisingly found the combination of post-emergent herbicidal active agent, particular glufosinate, the residual control agent, and the burndown agent, could form a compatible, stable, and effective composition that advantageously provides users with early burndown symptoms of weeds, residual activity, and an extended herbicidal efficacy using one single composition. It is note that the specific concentrations of post-emergent herbicidal active agent, the residual control active agent, and the burndown agents, as well as the relative weight ratio of these constituting components according to the present disclosure are important to demonstrate an enhanced effect on weed and/or grass control.

In some embodiments, the burndown agent comprises a fatty acid compound. In particular embodiments, the fatty acid compound is a fatty acid salt having the following formula (I):

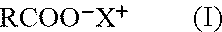

wherein, R is a C₆ to C₁₉, or C₇ to C₁₁, or C₈ to C₁₀ hydrocarbyl group optionally substituted with a hydroxyl or a C₁-C₅ hydrocarbyl group; and X is an ammonium, an alkali metal, an alkaline earth metal, or any combinations thereof.

Non-limiting examples of the fatty acid salt includes Enanthic acid (CH₃(CH₂)₅COO⁻X⁺), Capric acid salt (CH₃(CH₂)₆COO⁻X⁺), Pelargonic acid or nonanoic acid salt (CH₃(CH₂)₇COO⁻X⁺), Capric acid or decanoic acid salt (CH₃(CH₂)₈COO⁻X⁺), Undecylic acid salt (CH₃(CH₂)₉COO⁻X⁺), Lauric acid (CH₃(CH₂)₁₀COO⁻X⁺), Tridecylic acid salt (CH₃(CH₂)₁₁COO⁻X⁺), and Myristic acid (CH₃(CH₂)₁₂COO⁻X⁺), Hexadecanoic acid (Palmitic acid) salt (CH₃(CH₂)₁₄COO⁻X⁺), Stearic acid salt (CH₃(CH₂)₁₆COO⁻X⁺), Oleic acid salt (CH₃(CH₂)₄CH=CHCH₂CH=CH(CH₂)₇COO⁻X⁺), or any combinations thereof.

In some embodiments, the burndown agent used herein is in a form of or derived from a fatty acid or fatty acid salt composition, such as cocoate, which is known as a mixture of free fatty acids derived from a “cracking” of coconut oil. A typical example of cocoate comprises C₆ to C₁₉ saturated or unsaturated fatty acids and/or salt thereof.

In particular embodiments, the fatty acid compound is at least one of: ammonium nonanoate, alkali nonanoate, alkaline earth nonanoate, ammonium decanoate, alkali decanoate, alkaline earth decanoate, ammonium cocoate, alkali cocoate, alkaline cocoate, or any combinations thereof. In certain embodiments, the fatty acid is ammonium nonanoate.

In some embodiments, the burndown agent comprises a dication compound. A non-limiting example of the dication compound is a diquat salt such as diquat dibromide or diquat dichloride.

In certain embodiments, the burndown agent is a fatty acid and a dication compound. In certain embodiments, the burndown agent comprises a fatty acid compound and is free or substantially free from a dication compound. In certain embodiments, the burndown agent comprises a dication compound and is free or substantially free from a fatty acid compound.

Some non-limiting examples of the herbicidal active agent according to the present disclosure are further described in Table 1.

TABLE 1

Non-limiting examples of the herbicidal active agent according to the present disclosure

| | | | | | | |
|---|---|---|---|---|---|---|
| Herbicidal active agent | Category | Mobility in plants | Symptoms | Application timing | Weed profile | Notes |
| Mesotrione | 4-HPPD inhibition | Systemic in seed, shoot and roots | Beaching and necrosis | Pre- and postemergence | Annual and perennial grasses and broadleaf weeds | Limited residual activity (6-15 days) |
| Sulcotrione | 4-HPPD inhibitor | Systemic, leaf and root uptake | Progressive bleaching | Pre- and postemergence | Annual grasses and broadleaf weeds | No residual activity |
| Benzobicyclon | 4-HPPD inhibitor | Systemic, leaf and root uptake | Chlorosis and death of growing points | Pre- and Postemergence | Grasses, broadleaf weeds, and sedge | 14 days residual activity |
| Tembotrione | 4-HPPD inhibitor | Systemic, readily transported to meristems | Whitening of apical meristem, necrosis, and death | Postemergence | Selective grasses and broadleaf weeds | 14 days residual activity |
| Isoxaflutole | 4-HPPD inhibitor | Systemic with translocation by xylem | Bleaching of new growth | Preemergence | Grasses and broadleaf weeds | No residual activity |
| Topramezone | 4-HPPD inhibitor | Systemic, root and shoot absorption | Bleaching and chlorosis of shoots | Pre- and postemergence | Annual grasses and broadleaf weeds | 14 days residual activity |
| Pyrazolate | 4-HPPD inhibitor | Root absorption and translocation by xylem | Bleaching of shoots | Postemergence | Grasses and sedges | 10-20 days residual activity |
| Pyrazoxyfen | 4-HPPD inhibitor | Absorbed through roots and stems and translocated by xylem | Bleaching and chlorosis | Pe- and postemergence | Annual and perennial grasses and broadleaf weeds | 4-15 days residual activity |
| Benzafenap | 4-HPPD inhibitor | Root and crown absorption | Chlorosis and bleaching | Preemergence | Broadleaf weeds | 38 days residual activity |
| Pyrasulfotole | 4-HPPD inhibitor | Root and crown absorption | Bleaching and chlorosis | Postemergence | Broadleaf weeds | |
| Imazapic | ALS/AHAS inhibitor | Systemic: translocated in plants | Stunting and general chlorosis | Postemergence | Annual and perennial grasses, broadleaf weeds, and purple and yellow nutsedge | Four months residual activity |
| Imazapyr | ALS/AHAS inhibitor | Systemic with foliar and root absorption and translocation | Stunting and general chlorosis | Postemergence | Grasses, broadleaf weeds, vines, bushes, and brushes | Four months residual activity |
| Imazethapyr | ALS/AHAS inhibitor | Systemic with rapid foliar absorption and translocation | Stunting, chlorosis, and necrosis | Preplant incorporation (PPI), pre- and postemergence | Annual grasses, broadleaf weeds and nutsedges | Two to three months residual |
| Ammonium nonanoate | Cell membrane disruptor | Contact with burndown activity | Darkening, water-soaking, wilting, desiccation, and death | Postemergence | Grasses and broadleaf weeds | Top kill, no residual activity |
| Capric/decanoate acid of salt thereof | Cell membrane disruptor | Contact with burndown activity | Chlorosis and necrosis | Postemergence | Small annual and perennial grasses and broadleaf weeds | No residual activity |
| Caprylic/octanoic acid | Cell membrane disruptor | Contact with burndown activity | Chlorosis and necrosis | Postemergence | Grasses and broadleaves grasses | No residual activity |
| Pelargonic acid | Cell membrane disruptor | Contact with burndown activity | Darkening, water-soaking, wilting, desiccation, and death | Postemergence | Annual and perennial grasses and broadleaf weeds, moss and cryptograms | No residual activity |
| Glufosinate | Inhibits glutamine synthase | Systemic with foliar absorption | Chlorosis, wilting, and necrosis | Postemergence | Annual and perennial grasses and broadleaf weeds | Kills shoots and roots, short residual activity |
| Diquat | Photosystem I (PSI) inhibitor | Limited translocation from leaves | Wilting, desiccation, and necrosis | Postemergence | Broadleaf weeds, algae, and aquatic weeds | No residual activity |
| Acifluorfen | PPO inhibitor | Readily absorbed by roots and leaves but limited translocation | Chlorosis, desiccation, and necrosis. | Postemergence | Annual grasses and broadleaf weeds | No residual activity |
| Azafenidin | PPO inhibitor | Absorbed through roots and shoots with limited translocation | Necrosis and death | Pre- and postemergence | Annual and perennial grasses and broadleaf weeds | 2 to 6 months residual depending on weed type |
| Bifenox | PPO inhibitor | Rapid foliar absorption but very little translocation | Chlorosis, desiccation, and necrosis | Postemergence | Grasses and broadleaf weeds and annual sedges | Six to eight weeks residual activity |
| Carfentrazone-ethyl | PPO inhibitor | Limited symplastic phloem movement due to rapid burndown | Necrosis and death | Postemergence | Broadleaf weeds and vines | No residual activity |
| Flumiclorac pentyl | PPO inhibitor | Readily absorbed into leaves with no translocation to roots | Wilting, bleaching, browning, desiccation & necrotic | Postemergence | Broadleaf weeds | No residual activity |
| Fluthiacet-methyl | PPO inhibitor | Little absorption that leads to basipetal translocation | Chlorotic, desiccation, necrosis, speckling & bronzing | Postemergence | Broadleaf weeds | No residual activity |
| Flumioxazin | PPO inhibitor | Systemic: good root and shoot absorption and translocation | Desiccations and necrosis of plant tissues | Pre- and postemergence | Broadleaf weeds | One to two weeks residual |
| Fomesafen | PPO inhibitor | Systemic root and foliar absorption | Chlorosis, desiccation, and necrosis | Postemergence | Broadleaf weeds | 12-month residual activity |
| Lactofen | PPO inhibitor | Systemic, foliar and root absorption | Chlorosis, desiccation and necrosis | Postemergence | Annual broadleaf weeds | Very short residual activity (2-3 weeks) |
| Oxadiargyl | PPO inhibitor | Limited shoot translocation | Necrosis and death | Pre- and postemergence | Annual grasses and broadleaf weeds | Pre-emergent active |
| Oxadiazon | PPO inhibitor | Shoot and emerging seedling absorption | Chlorosis, wilt, necrosis and desiccation | Preemergence and PPI | Annual grasses and broadleaf weeds | Moderate residual activity (2 months) |
| Oxyfluorfen | PPO inhibitor | Systemic with limited translocation in roots and shoots | Beaching, desiccation, and necrosis | Pre- and postemergence | Annual and perennial grasses and broadleaf weeds, nutsedges, | Kills shoots and roots, 30 d residual |
| Saflufenacil | PPO inhibitor | Contact and systemic/ rapid foliar absorption | Chlorosis and necrosis | Postemergence | Broadleaf weeds | No residual activity |
| Pentoxazone | PPO inhibitor | Systemic root and shoot absorbed | Chlorosis, wilt, necrosis & desiccation | Pre- and postemergence | Annual grasses and broadleaf weeds | No residual activity |
| Pyraclonil | PPO inhibitor | Systemic root and shoot absorbed | Chlorosis, wilt, necrosis & desiccation | Pre- and postemergence | Grasses and broadleaf weeds | To be determined |
| Pyraflufen-ethyl | PPO inhibitor | Contact with limited translocation | Necrosis and desiccation | Postemergence | Broadleaf weeds | Burndown activity with no residual |
| Tiafenacil | PPO inhibitor | Contact with burndown activity | Necrosis and desiccation | Postemergence | Annual grasses and broadleaf weeds | Burndown with no residual activity |
| Trifludimoxazin | PPO inhibitor | Burndown activity | Necrosis and desiccation | Pre-plant and preemergence | Broadleaf and grass weeds | Short residual activity of 40 days |
| Cinidon-ethyl | PPO inhibitor | Foliar and root absorption with minimal translocation | Chlorosis, wilt, necrosis & desiccation | Postemergence | Annual grasses and broadleaf weeds | No residual activity |
| Flufenpyr-ethyl | PPO inhibitor | Absorbed by roots and leaves but limited translocation | Bronzing and necrosis | Postemergence | Broadleaf weeds | No residual activity |
| Butafenacil | PPO inhibitor | Absorbed by roots, leaves, and stems but limited translocation | Rapid chlorosis, necrosis, and death | Pre- and postemergence | Broadleaf weeds | No residual activity |
| Fluazolate | PPO inhibitor | Absorbed mostly by leaves, with limited translocation | Chlorosis, bronzing, desiccation, and necrosis | Preemergence | Annual grasses and broadleaf weeds | Short to moderate residual activity (4 - 6 weeks) |
| Aclonifen | Solanesyl diphosphate synthase inhibitor | Systemic, absorbed by roots and leaves. | Bleaching, necrosis and death | Preemergence | Annual grasses and broadleaf weeds | Moderate residual activity |
| Fluoroglycofen-ethyl | PPO inhibitor | Rapid root and foliar absorption but limited translocation | Foliar necrosis and desiccation | Postemergence | Broadleaf weeds | No residual activity |
| Ipfencarbazone | VLCFA inhibitor | Rapid absorption by roots and crown and translocation to other parts | Stunting, greening, unfurling and twisting of leaves | Pre- and postemergence | Annual grasses, broadleaf weeds, and sedges | 70 days residual activity |

In some embodiments, the composition has a ratio of post-emergent herbicidal active agent to the residual control active agent from about from about 2,000:1 to about 1:100, from about 1,000:1 to about 1:10, from about 500:1 to about 1:1, from about 100:1 to about 1:1, from about 50:1 to about 1:1, from about 10:1 to about 1:1, from about 8:1 to about 1:1, from about 5:1 to about 1:1. In some embodiments, the ratio of post-emergent herbicidal active agent to the residual control active agent is at least about 1:1, at least about 2:1, at least about 3:1, at least about 4:1, at least about 5:1, at least about 6:1, at least about 7:1, at least about 8:1, or at least about 1:1, at least about 10:1, at least about 12:1, at least about 15:1, at least about 20:1, at least about 25:1, at least about 50:1, or at least about 100:1. In some embodiments, the ratio of post-emergent herbicidal active agent to the residual control active agent is at most 100:1, at most about 50:1, at most about 40:1, at most about 30:1, at most about 27:1, at most about 20:1, at most about 15:1, at most about 10:1, at most about 8:1, at most about 7:1, at most about 6:1, at most about 5:1, at most about 4:1, at most about 3:1, at most about 2:1, or at most about 1:1.

In some embodiments, the composition has a ratio of post-emergent herbicidal active agent to the burndown agent from about 100:1 to about 1:100, from about 50:1 to about 1:50, from about 20:1 to about 1:20, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1. In some embodiments, the ratio of post-emergent herbicidal active agent to the burndown agent is at least about 1:100, at least about 1:50, at least about 1:20, at least about 1:10, at least about 1:8, at least about 1:6, at least about 1:4, at least about 1:2, or at least about 1:1. In some embodiments, the ratio of post-emergent herbicidal active agent to the burndown agent is at most 100:1, at most about 50:1, at most about 20:1, at most about 10:1, at most about 1:1, at most about 1:2, at most about 1:4, at most about 1:6, at most about 1:8, at most about 1:10, at most about 1:20, at most about 1:50, or at most about 1:100.

In some embodiments, the composition has a weight ratio of the residual control active agent to the burndown agent from about 100:1 to about 1:500, from about 10:1 to about 1:200, from about 1:1 to about 1:200, from about 1:1 to about 1:150, from about 1:1 to about 1:100, from about 1:1 to about 1:60, from about 1:5 to about 1:30, from about 1:10 to about 1:200, from about 1:10 to about 150, from about 1:10 to about 1:100, from about 1:10 to about 1:50, from about 1:10 to about 1:40, from about 1:10 to about 1:30, or from about 1:15 to about 1:50, or from about 1:35 to about 1:150. In some embodiments, the ratio of the residual control active agent to the burndown agent is at least about 1:200, at least about 1:150, at least about 1:132, at least about 1:100, at least about 1:80, at least about 1:60, at least about 1:40, at least about 1:30, at least about 1:20, at least about 1:10, or at least about 1:1. In some embodiments, the ratio of the residual control active agent to the burndown agent is at most about 1:1, at most about 1:5, at most about 1:10, at most about 1:20, at most about 1:40, at most about 1:60, at most about 1:80, at most about 1:10, at most about 1:132, at most about 1:150, at most about 1: 200, or at most about 1:500.

In certain embodiments, the ratio of the post-emergent herbicidal active agent to the residual control active agent is from about 30:1 to about 1:1, or from about 27:1 to about 1:1, or from about 20:1 to about 2:1, or from about 15:1 to about 3:1, or from about 10:1 to about 4:1, or from about 8:1 to about 5:1.

In certain embodiments, the ratio of the post-emergent herbicidal active agent to the burndown agent is from about 1:7 to about 1:1, from about 1:6 to about 1:1, from about 1:5 to about 1:1, from about 1:4 to about 1:1, from about 1:3 to about 1:1, or from about 1:2 to about 1:1.

In certain embodiments, the ratio of the residual control active agent to the burndown agent is from about 1:1 to about 1:500, or about 1:5 to about 1:500, about 1:10 to about 1:500, about 1:10 to about 1:150, or from about 1:10 to about 1:132, or from about 1:10 to about 1:40, or from about 1:15 to about 1:50, or from about 1:35 to about 1:150.

In some embodiments, the present herbicide composition further comprises a carrier. The carrier may be liquid or solid. Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller’s earth, cottonseed hulls, wheat flour, soybean flour, pumice, wood flour, walnut shell flour, lignin, cellulose, and the like.

In some embodiments, the present herbicide composition optionally comprises a functional ingredient. Non-limiting examples of the functional ingredient include an additional herbicidal active ingredient, a surfactant (surface-active agent), an emulsifier, a dispersing agent, a stabilizer, a foam-moderating agent, a preservative, an anti-freeze agents, a solubility-enhancing agent, a dye or colorant, a pH modifier, a thickening agent, an agriculturally acceptable fragrance, an agriculturally acceptable adjuvant, an agriculturally acceptable excipient, a fertilizer, a rainfast agent, or any combinations thereof.

In some embodiments, the surface-active agents described herein are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; poly-ethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters. In some embodiments, the herbicide composition has a concentration of the surfactant (or surface active agent) from about 0.01 wt% to about 10 wt%, or from about 0.1 wt% to about 8 wt%, from about 0.5 wt% to about 5 wt%, or from about 1 wt% to about 3 wt%, based on the total weight of the herbicide composition. In some embodiments, the herbicide composition is a RTU solution having a concentration of the surfactant from about 0.001 wt% to about 2 wt%, or from about 0.005 wt% to about 1 wt%, or from about 0.01 wt% to about 0.5 wt%, based on the total weight of the RTU solution.

In some embodiments, the post-emergent herbicidal active agent has a concentration from about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition. In certain embodiments, the present composition is a liquid herbicide concentrate and has a concentration of the post-emergent herbicidal active agent from about 1 wt% to about 20 wt %, or from about 1 wt% to about 10 wt%, or from about 1 wt % to about 8 wt%, or from about 1 wt% to about 6 wt%, or from about 1 wt% to about 4 wt%, or from about 1 wt% to about 2 wt%, based on the total weight of the herbicide concentrate.

In some embodiments, the residual control active agent has a concentration from about 0.001 wt% to about 10 wt%, from about 0.05 wt% to about 5 wt%, from about 0.1 wt% to about 5 wt%, from about 0.5 wt% to about 2 wt%, based on the total weight of the composition. In certain embodiments, the present composition is a liquid herbicide concentrate and has a concentration of the residual control active agent from about 0.01 wt% to about 10 wt %, or from about 0.1 wt% to about 15 wt%, or from about 0.5 wt % to about 10 wt%, or from about 1 wt% to about 5 wt%, based on the total weight of the herbicide concentrate.

In some embodiments, the burndown agent has a concentration from about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition. In certain embodiments, the present composition is a liquid herbicide concentrate and has a concentration of the burndown agent from about 1 wt% to about 40 wt %, or from about 1 wt% to about 30 wt%, or from about 1 wt % to about 20 wt%, or from about 1 wt% to about 10 wt%, or from about 1 wt% to about 5 wt%, based on the total weight of the herbicide concentrate.

In some embodiments, the present composition is a RTU herbicide composition. The RTU composition can be made by dilution of a herbicide concentrate described herein or by dilution of each constituting component separately followed by a combination of the diluted components. In some embodiments, the RTU composition has a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution. In some embodiments, the RTU composition has a concentration of the residual control active agent from about 0.001 wt% to about 1 wt%, from about 0.005 wt% to about 0.5 wt%, from about 0.01 wt% to about 0.05 wt%, based on the total weight of the RTU solution. In some embodiments, the RTU solution has a concentration of the burndown agent from about 0.1 wt% to about 20 wt%, from about 0.5 wt% to about 10 wt%, from about 1 wt% to about 5 wt%, based on the total weight of the RTU solution.

In particular examples, a non-selective herbicide composition comprises: from about 0.01 wt% to about 20 wt% of a post-emergent herbicidal active agent selected from glufosinate or a salt or derivative thereof; from about 0.001 wt% to about 10 wt% of a residual control active agent comprising a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof; from about 0.05 wt% to about 50 wt% of a burndown agent comprising a fatty acid compound, or an organic dication compound such as diquat dibromide, or any combinations thereof; and a carrier, wherein the composition has a weight ratio of the post-emergent herbicidal active agent to the residual control active agent from about 50:1 to about 1:1, wherein the composition has a weight ratio of the post-emergent herbicidal active agent to the burndown agent from about 10:1 to about 1:10, wherein the composition has a weight ratio of the residual control active agent to the burndown agent from about 1:5 to about 1:500. In certain embodiments, the post-emergent herbicidal active agent is glufosinate or derivative or salt thereof; the residual active agent is selected from flumioxazin, imazapic, imazapyr, imazethapyr, topramezone or any combinations thereof; and the burndown agent is selected from ammonium nonanoate, alkali nonanoate, alkaline earth nonanoate, ammonium decanoate, alkali decanoate, alkaline earth decanoate, diquat dichloride, diquat dibromide, or any combinations thereof.

In particular examples, a non-selective herbicide RTU composition comprises: from about 0.1 wt% to about 0.5 wt% of glufosinate or a salt or derivative thereof; from about 0.01 wt% to about 0.1 wt% of flumioxazin; from about 1 wt% to about 5 wt% of ammonium nonanoate; and water, wherein the composition has a weight ratio of glufosinate to flumioxazin about 24:1 or less, 10:1 or less, or 5:1 or less, wherein the composition has a weight ratio of glufosinate to ammonium nonanoate about 1:10 or less, wherein the composition has a weight ratio of flumioxazin to ammonium nonanoate about 1:5 or less, 1:10 or less, about 1:35 or less, about 1:100 or less. In certain embodiments, the weight ratio of glufosinate to flumioxazin is from about 24:1 to about 1:1, about 8:1 to about 1:1, about 8:1 to about 5:1, or about 5:1 to about 1:1, the weight ratio of glufosinate to ammonium nonanoate is from about 7:1 to about 1:1, and the weight ratio of flumioxazin to ammonium nonanoate is from about 1:5 to about 1:500.

In particular examples, a non-selective herbicide RTU composition comprises: from about 0.1 wt% to about 0.5 wt% of glufosinate or a salt or derivative thereof; from about 0.01 wt% to about 0.1 wt% of flumioxazin; from about 1 wt% to about 5 wt% of a diquat compound; and water, wherein the composition has a weight ratio of glufosinate to flumioxazin about 24:1 or less, 10:1 or less, or 5:1 or less, wherein the composition has a weight ratio of glufosinate to diquat compound about 1:10 or less, wherein the composition has a weight ratio of flumioxazin to diquat compound about 1:10 or less. In certain embodiments, the weight ratio of glufosinate to flumioxazin is from about 24:1 to about 1:1, about 10:1 to about 1:1, about 8:1 to about 5:1, about 8:1 to about 1:1, or about 5:1 to about 1:1, the weight ratio of glufosinate to the diquat compound is from about 1:1 to about 1:10, and the weight ratio of flumioxazin to the diquat compound is from about 1:5 to about 1:500.

In particular examples, a non-selective herbicide RTU composition comprises: from about 0.1 wt% to about 0.5 wt% of glufosinate or a salt or derivative thereof; from about 0.01 wt% to about 0.15 wt% of an ALS/ALHS inhibitor selected from imazapic, imazapyr, imazethapyr, or derivatives thereof, or any combinations thereof; from about 1 wt% to about 5 wt% of a burndown agent selected from ammonium nonanoate, a diquat compound, or both; and water, wherein the composition has a weight ratio of glufosinate to the ALS/ALHS inhibitor about 10:1 or less, wherein the composition has a weight ratio of glufosinate to the burndown agent about 1:10 or less, wherein the composition has a weight ratio of the ALS/ALHS inhibitor to the burndown agent about 65:1 or less. In certain embodiments, the weight ratio of glufosinate to the ALS/ALHS inhibitor is from about 10:1 to about 3:1, the weight ratio of glufosinate to the burndown agent is from about 7:1 to about 1:1, and the weight ratio of the ALS/ALHS inhibitor to the burndown agent is from about 1:5 to about 1:500. In certain embodiments, the ALS/ALHS inhibitor is imazapyr and the burndown agent is ammonium nonanoate, and the ratio of the imazapyr to ammonium nonanoate is from about 1:10 to about 1:40. In certain embodiments, the ALS/ALHS inhibitor is imazapic and the burndown agent is ammonium nonanoate, and the ratio of the imazapic to ammonium nonanoate is from about 1:10 to about 1:500, or from about 1:15 to about 1:50.

In particular examples, a non-selective herbicide RTU composition comprises: from about 0.1 wt% to about 0.5 wt% of glufosinate or a salt or derivative thereof; from about 0.01 wt% to about 0.05 wt% of topramezone; from about 1 wt% to about 5 wt% of a burndown agent selected from ammonium nonanoate, a diquat compound, or both; and water, wherein the composition has a weight ratio of glufosinate to topramezone about 1:20 or less, wherein the composition has a weight ratio of glufosinate to the burndown agent about 1:10 or less, wherein the composition has a weight ratio of topramezone to the burndown agent about 1:100 or less. In certain embodiments, the weight ratio of glufosinate to topramezone is from about 20:1 to about 5:1, the weight ratio of glufosinate to the burndown agent is from about 1:1 to about 1:7, and the weight ratio of topramezone to the burndown agent is from about 1:10 to about 1:500.

In the practice of the present teachings, the pH of the herbicidal composition is preferably controlled in order to obtain a storage stable formulation and one that effectively provides the desired fast developing symptomology. More particularly, in some embodiments, the final pH of the herbicidal composition is controlled in the range of from about 2 to about 10, or from about 4 to about 9, or from about 6 to about 8. If the pH of the final composition is beyond such pH range, the burndown agents may tend to separate from the composition upon standing and it may be necessary for the user to shake or agitate the composition to obtain a uniform solution to spray. In some embodiments, the herbicide composition or RTU composition according to the present disclosure has a pH from about 6.0 to about 9.0, or from about 6.4 to about 7.8, or from about 6.8 to about 7.4, or from about 6.8 to about 7.0. In certain embodiments, the final pH of the RTU composition is controlled in the range of from about 7.1 to about 7.6, from 7.2 to about 7.5, from about 7.25 to about 7.4, or at about 7.3.

If pH adjustment is necessary, it is readily achieved by the addition of pH adjusting base or acidic component (or pH modifier or the like) during the formulation preparation process. Suitable bases for pH adjustment include those providing hydroxide in water, or an amine or alkali metal or alkaline earth metal hydroxide, or potassium hydroxide.

The herbicidal compositions (concentrates or RTU compositions) of the present disclosure may be readily prepared by simple mixing of the various components and optional ingredients in the desired quantities using a stirrer or any other suitable container or device producing the necessary amount of agitation or circulation to thoroughly mix the ingredients. In one example, an herbicidal RTU composition may be formulated by first adding/dissolving/diluting/mixing the source of burndown agent or other optional functional ingredients in a carrier such as water or a buffer or an pre-formed emulsion, adding the source of glufosinate component and optional surfactant component, followed by addition of the source of pH modifier or other suitable adjuvants. In alternative embodiments, a killed artisan would appreciate the criticality of stepwise addition of various ingredients in a particular sequence to achieve a final stable herbicidal composition according to the present disclosure.

The compositions of the present disclosure can be readily used as prepared or further diluted in a carrier such as water by a user in a spray container prior to use, although those of skill in the art will recognize that the dilution will have a practical dilution limit set by efficacy.

Suitable herbicidally efficacious application rates of the present compositions will vary depending on concentration of the composition and/or the target plant species, weather, climate, and geography. The spray volume is in the range from about 10 to about 1,000 gallons per acre (gpa), or from about 50 to about 500 gpa, or from about 100 to about 250 gpa.

The present compositions when applied to an area in need of weed control cause early burndown symptoms of weeds or undesired plants in the area, or induce early appearance of visual phytotoxic effects in treated plants. It is noted that the present compositions having a combination of the post-emergent herbicide active agent, the residual control active agent, and the burndown agent are demonstrated to have the early burndown effect leaving intact the long term control weed efficacy provided by the post-emergent herbicide active agent, as well as the residual activity provided by the residual control active agent. Particularly, in some embodiments, the present compositions present both early burndown symptoms of the treated plants and an enhanced effect on weed control, and residual activity that extends the herbicidal efficacy for a longer period of time, as compared with the control compositions.

In some examples, the present disclosure also provides methods for killing, or controlling, or inhibiting, or otherwise reducing growth of weeds or grasses in an area in need thereof. In one example, a method for control of annual and perennial grasses and broadleaf weeds comprises: treating an area in need of weed control with any herbicide composition described herein. The treatment comprises applying a herbicidally effective amount of the herbicide composition to the area. In some embodiments, the treatment comprises spraying a herbicidally effective amount of the herbicide composition stored in a spray container to the area. The compositions can be sprayed onto the surface of the area, or soil therein, or any undesired weeds or grasses grow or will grow therein. The compositions sprayed onto the area may or may not be in contact with the weeds or grass. In some embodiments, the compositions are sprayed onto foliage of the weeds or grasses.

The herbicidal sprayable RTU compositions included in the present disclosure can be applied to the foliage of the plants to be treated through any of the appropriate methods that are well known to those having skill in the art. In one embodiment, the RTU composition is packaged in a portable container suitable for hand carry by the user and fitted with an apparatus for manually releasing the composition from the container onto the foliage of the plants to be treated in the form of a spray.

The area to be treated may be a residential, industrial, or commercial area, including but not limited to landscape edge, a non-crop area around farmsteads, building foundation, a shelter belt, a fencerow, a driveway, a sidewalk, a paver patio, a gravel area, an area under deck, a parking area, a walkway, a garden, a lawn, and any unplanted area where no weeds are desired. In particular embodiments, the area is a residential area.

In some embodiments, treatment of the area causes early burndown or injury symptoms of weeds or undesired plants, such as yellowing, wilting, browning, necrosis, about 15 minutes to about 6 hours, or about 30 minutes to about 4 hours, or about 1 hour to about 3 hours.

In some embodiments, treatment of the area causes at least about 10% weed/grass control within about 3 hours after application of the composition, at least about 15% weed/grass control within about 6 hours after application of the composition, at least about 30% weed/grass control within about 24 hours after application of the composition, at least about 70% weed/grass control within about 7 days after application of the composition, at least about 90% weed/grass control within about 21 days after application of the composition, at least about 90% weed/grass control within about 30 days after application of the composition, at least about 90% weed/grass control within about 45 days after application of the composition, at least about 90% weed/grass control within about 60 days after application of the composition, at least about 90% weed/grass control within about 90 days after application of the composition.

In some embodiments, treatment of the area causes long-term control efficacy and remains effective for at least 15 days, at least 45 days, at least 60 days, at least 90 days, at least 120 days, at least 150 days, at least 180 days, at least 210 days, at least 240 days, at least 270 days, at least 300 days, or at least 360 days, or 1 year (365/6 days), after application of the composition without reapplication. In certain embodiments, the herbicidal efficacy remains at least about 80%, at least about 85%, at least about 90%, at least about 95%, at least about 96%, at least about 97%, at least about 98%, at least about 99%, or at least about 100% weed/grass control of the treated area for a period of time of at least about 1 week, at least about 2 weeks, at least about 3 weeks, at least about 4 weeks (or 1 month), at least about 2 months, at least about 3 months, at least about 4 months, at least about 5 months, at least about 6 months, at least about 7 months, at least about 8 months, at least about 9 months at least about 10 months, at least about 11 months, or at least about 12 months (1 year) after application of the composition.

In some embodiments, the present method further comprises: applying a maintenance composition. The maintenance composition may comprise a herbicidally active ingredient selected from a post-emergent herbicidal active agent, a residual control active agent, a burndown agent, as described in the present disclosure, or any combinations thereof. The maintenance composition may be used to further improve the herbicidal efficacy, or maintain the herbicidal efficacy for an extended period of time, or both. In certain embodiments, the maintenance composition is the same or substantially same as the herbicidal composition that has been applied. In certain embodiments, the maintenance composition is a commercially available herbicide composition. In certain embodiments, the maintenance composition comprises from about 0.05 wt% to about 20 wt% of glufosinate or salt or derivative thereof.

The maintenance composition may be applied at least about 15 days, at least about 30 days, at least about 45 days, or at least about 60 days after applying the herbicide composition. In some embodiments, the method comprises applying the maintenance composition multiple times sequentially or in a coordinated fashion with the herbicide composition of the present disclosure.

Application of the maintenance composition may cause a longer term control efficacy of the treated area and may maintain the efficacy of the applied herbicide composition for a total of at least about 1 month, at least about 2 months, at least about 3 months, at least about 4 months, at least about 5 months, at least about 6 months, at least about 7 months, at least about 8 months, at least about 9 months at least about 10 months, at least about 11 months, or at least about 12 months (1 year), at least 15 months, at least 18 months, at least 21 months, or at least 24 months (2 years) after the application of the herbicide composition.

The present methods are further described in the following embodiments. In some particular embodiments, a method for control of annual and perennial grasses and broadleaf weeds, comprising applying a non-selective herbicide composition, the composition comprising: from about 0.01 wt% to about 20 wt% of a post-emergent herbicidal active agent selected from glufosinate or a salt or derivative thereof; from about 0.001 wt% to about 10 wt% of a residual control active agent comprising a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof; from about 0.05 wt% to about 50 wt% of a burndown agent comprising a fatty acid compound, or an organic dication compound such as diquat dibromide, or any combinations thereof; and a carrier, wherein the herbicide composition has a weight ratio of the post-emergent herbicidal active agent to the residual control active agent from about 50:1 to about 1:1, wherein the herbicide composition has a weight ratio of the post-emergent herbicidal active agent to the burndown agent from about 10:1 to about 1:10, wherein the herbicide composition has a weight ratio of the residual control active agent to the burndown agent from about 1:5 to about 1:500. In certain embodiments, the post-emergent herbicidal active agent is glufosinate or derivative or salt thereof; the residual active agent is selected from flumioxazin, imazapic, imazapyr, imazethapyr, topramezone or any combinations thereof; and the burndown agent is selected from ammonium nonanoate, alkali nonanoate, alkaline earth nonanoate, ammonium decanoate, alkali decanoate, alkaline earth decanoate, diquat dichloride, diquat dibromide, or any combinations thereof.

In particular examples, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 0.01 wt% to about 0.1 wt% of flumioxazin; from about 1 wt% to about 5 wt% of ammonium nonanoate; and water, wherein the RTU composition has a weight ratio of glufosinate to flumioxazin about 24:1 or less, 10:1 or less, or 5:1 or less, wherein the RTU composition has a weight ratio of glufosinate to ammonium nonanoate about 1:10 or less, wherein the RTU composition has a weight ratio of flumioxazin to ammonium nonanoate about 1:5 or less, 1:10 or less, about 1:35 or less, about 1:100 or less. In certain embodiments, the weight ratio of glufosinate to flumioxazin is from about 24:1 to about 1:1, about 10:1 to about 1:1, about 8:1 to about 5:1, about 8:1 to about 1:1, or about 5:1 to about 1:1, the weight ratio of glufosinate to ammonium nonanoate is from about 7:1 to about 1:1, and the weight ratio of flumioxazin to ammonium nonanoate is from about 1:35 to about 1:500.

In particular examples, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 0.01 wt% to about 0.1 wt% of flumioxazin; from about 1 wt% to about 5 wt% of a burndown agent selected from ammonium nonanoate, a diquat compound, or both;; and water, wherein the RTU composition has a weight ratio of glufosinate to flumioxazin about 24:1 or less, 10:1 or less, or 5:1 or less, wherein the RTU composition has a weight ratio of glufosinate to diquat compound about 1:10 or less, wherein the RTU composition has a weight ratio of flumioxazin to diquat compound about 1:10 or less. In certain embodiments, the weight ratio of glufosinate to flumioxazin is from about 24:1 to about 1:1, about 10:1 to about 1:1, about 8:1 to about 5:1, about 8:1 to about 1:1, or about 5:1 to about 1:1, the weight ratio of glufosinate to the diquat compound is from about 1:1 to about 1:20, and the weight ratio of flumioxazin to the diquat compound is from about 1:5 to about 1:500.

In particular examples, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 0.01 wt% to about 0.05 wt% of an ALS/ALHS inhibitor selected from imazapic, imazapyr, imazethapyr, or derivatives thereof, or any combinations thereof; from about 1 wt% to about 5 wt% of a burndown agent selected from ammonium nonanoate, a diquat compound, or both; and water, wherein the RTU composition has a weight ratio of glufosinate to the ALS/ALHS inhibitor about 10:1 or less, wherein the RTU composition has a weight ratio of glufosinate to the burndown agent about 1:10 or less, wherein the RTU composition has a weight ratio of the ALS/ALHS inhibitor to the burndown agent about 1:10 or less. In certain embodiments, the weight ratio of glufosinate to the ALS/ALHS inhibitor is from about 8:1 to about 5:1, the weight ratio of glufosinate to the burndown agent is from about 7:1 to about 1:1, and the weight ratio of the ALS/ALHS inhibitor to the burndown agent is from about 1:10 to about 1:132. In certain embodiments, the ALS/ALHS inhibitor is imazapyr and the burndown agent is ammonium nonanoate, and the ratio of the imazapyr to ammonium nonanoate is from about 1:10 to about 1:40. In certain embodiments, the ALS/ALHS inhibitor is imazapic and the burndown agent is ammonium nonanoate, and the ratio of the imazapic to ammonium nonanoate is from about 1:10 to about 1:500, or from about 1:15 to about 1:50.

In particular examples, a method for control of annual and perennial grasses and broadleaf weeds, comprising applying a non-selective herbicide RTU composition, the RTU composition comprising: from about 0.1 wt% to about 0.5 wt% of glufosinate or a salt or derivative thereof; from about 0.01 wt% to about 0.05 wt% of topramezone; from about 1 wt% to about 5 wt% of a burndown agent selected from ammonium nonanoate, a diquat compound, or both; and water, wherein the RTU composition has a weight ratio of glufosinate to topramezone about 10:1 or less, wherein the RTU composition has a weight ratio of glufosinate to the burndown agent about 1:10 or less, wherein the RTU composition has a weight ratio of topramezone to the burndown agent about 1:10 or less. In certain embodiments, the weight ratio of glufosinate to topramezone is from about 8:1 to about 5:1, the weight ratio of glufosinate to the burndown agent is from about 7:1 to about 1:1, and the weight ratio of topramezone to the burndown agent is from about 1:10 to about 1:500, or about 1:10 to about 1:132.

In some particular embodiments, a method for control of annual and perennial grasses and broadleaf weeds, comprising: (1) applying a non-selective herbicide RTU composition, the RTU composition comprising: from about 0.1 wt% to about 0.5 wt% of glufosinate or a salt or derivative thereof; from about 0.01 wt% to about 0.15 wt% of a residual active agent selected from flumioxazin, imazapic, imazapyr, imazethapyr, topramezone or any combinations thereof; from about 1 wt% to about 5 wt% of a burndown agent selected from ammonium nonanoate, diquat dichloride, diquat dibromide, or any combinations thereof; and water, wherein the composition has a weight ratio of the glufosinate to the residual control active agent from about 50:1 to about 1:1, wherein the RTU composition has a weight ratio of the glufosinate to the burndown agent from about 10:1 to about 1:10, wherein the RTU composition has a weight ratio of the residual control active agent to the burndown agent from about 1:5 to about 1:500; and (2) applying a maintenance composition, the maintenance composition comprising from about 0.1 wt% to about 0.5 wt% of glufosinate or a salt or derivative thereof.

### EXAMPLES

Certain embodiments of the present disclosure are further described with reference to the following experiments and examples. These experiments, examples, and samples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

### Compositions

Various examples and comparatives examples of the weed control compositions and RTU solutions were prepared according to Table 2. The RTU solutions were applied to test fields with various types of weeds and grasses, and the burndown effect and/or the long-term efficacy of the test RTU solutions are observed and compared. Equipment, sprayer, and selected operating conditions for application of the RTU compositions to the test areas are provided in Table 3.

TABLE 2

Example weed control compositions prepared according to the present disclosure

| | |
|---|---|
| Example Compositions | Selected Ingredients |
| Example 1 | Glufosinate: 0.42 wt% |
| | Ammonium Nonanoate: 0.31 wt% |
| Example 2 | Glufosinate: 0.42 wt% |
| | Ammonium Nonanoate: 0.62 wt% |
| Example 3 | Glufosinate: 0.42 wt% |
| | Ammonium Nonanoate: 1.25 wt% |
| Example 4 | Glufosinate: 0.42 wt% |
| | Ammonium Nonanoate: 1.87 wt% |
| Example 5 | Glufosinate: 0.42 wt% |
| | Ammonium Nonanoate: 2.50 wt% |
| Example 6 | Glufosinate: 0.42 wt% |
| | Ammonium Nonanoate: 2.50 wt% |
| Example 7 | Glufosinate: 0.42 wt% |
| | Diquat: 1 wt% |
| Example 8 | Glufosinate: 0.42 wt% |
| | Diquat: 2 wt% |
| Example 9 | Glufosinate: 0.42 wt% |
| | Diquat: 3 wt% |
| Example 10 | Glufosinate: 0.42 wt% |
| | Ammonium Nonanoate: 1.87 wt% |
| | Ammonium salt of imazapic: 0.044% |
| Example 11 | Glufosinate: 0.42 wt% |
| | Ammonium Nonanoate: 1.87 wt% |
| | Ammonium salt of imazapic: 0.088% |
| Example 12 | Glufosinate: 0.42 wt% |
| | Ammonium Nonanoate: 1.87 wt% |
| | Ammonium salt of imazapic: 0.13 wt% |
| Example 13 | Glufosinate: 0.42 wt% |
| | Ammonium Nonanoate: 1.87 wt% |
| | Imazapyr: 0.051 wt% |
| Example 14 | Glufosinate: 0.42 wt% |
| | Ammonium Nonanoate: 1.87 wt% |
| | Imazapyr: 0.10 wt% |
| Example 15 | Glufosinate: 0.42 wt% |
| | Ammonium Nonanoate: 1.87 wt% |
| | Imazapyr: 0.15 wt% |
| Example 16 | Glufosinate: 0.42 wt% |
| | Ammonium Nonanoate: 1.87 wt% |
| | Flumioxazin: 0.016 wt% |
| Example 17 | Glufosinate: 0.42 wt% |
| | Ammonium Nonanoate: 1.87 wt% |
| | Flumioxazin: 0.031 wt% |
| Example 18 | Glufosinate: 0.42 wt% |
| | Ammonium Nonanoate: 1.87 wt% |
| | Flumioxazin: 0.062 wt% |
| Example 19 | Glufosinate: 0.42 wt% |
| | Flumioxazin: 0.09 wt% |
| Example 20 | Glufosinate: 0.26 wt% |
| | Flumioxazin: 0.09 wt% |
| Example 21 | Glufosinate: 0.26 wt% |
| | Topramezone: 0.02 wt% |
| Example 22 | Glufosinate: 0.21 wt% |
| | Ammonium Nonanoate: 1.87 wt% |
| Comparative Example 1 | Glufosinate (enantiomers): 0.42 wt% |
| Comparative Example 2 | L-Glufosinate: 0.42 wt% |

### General Procedures of Treatment

All field experiments were set in 1 m² plots replicated four times in a randomized complete block design with appropriate industry standards and untreated controls. The example compositions and comparative example compositions according to Table 2 were tested in the field experiments. Efficacy was investigated for burndown weed control, established weed control, and residual weed control, including preventing germination of new seedsfor selected weeds including: annual and perennial broadleaf weeds (water pennyworth, common dandelion, crimson clover, water couch, California burclover, white clover, virginia buttonweed, matchweed, sprawling horseweed, common lespedeza), and for annual and perennial grasses and/or weeds (annual ryegrass, rescuegrass, common bermudagrass, king ranch bluestem, common carpetgrass, pensacola bahiagrass, St Augustine grass, dallisgrass, smooth crabgrass, torpedograss). The tested compositions were each applied to the plot using the equipment and conditions according to Table 3. The weed density in all experimental plots was at least 30% or more and at least between 2-6 inches in height (BBCH growth stage). Treatments were applied when soil temperatures were 60° F. or higher, air temperature was between 68° F. and 89° F., and relative humidity was 55%. Experimental plots were treated using a backpack sprayer as described in the application equipment table. Plots were sprayed once, and then assessed for speed to visible activity, percent (%) weed control, and percent residual control over time to determine burndown activity, speed to kill, extended control and residual pre-emergent activity.

TABLE 3

Equipment and conditions for application of the weed control RTU compositions

| | |
|---|---|
| Application Equipment | Sprayer |
| Equipment Type | BACCAI |
| Operation Pressure | 40 PSI |
| Nozzle Type | FLAEVE |
| Nozzle Size | 8015 |
| Nozzle Spacing | 20.0 IN |
| Nozzles/Row | 1.0 |
| Band Width | 20.0 IN |
| % Coverage | 100 |
| Boom ID | SINGLE WAND |
| Boom Height | 12.0 IN |
| Ground Speed | 3 MPH |
| Mix Size | 0.5 Gallon |
| Spray pH | 7.1 |
| Propellant | COMCO₂ |
| Tank Mix (Y/N) | Y |

### Results and Discussion

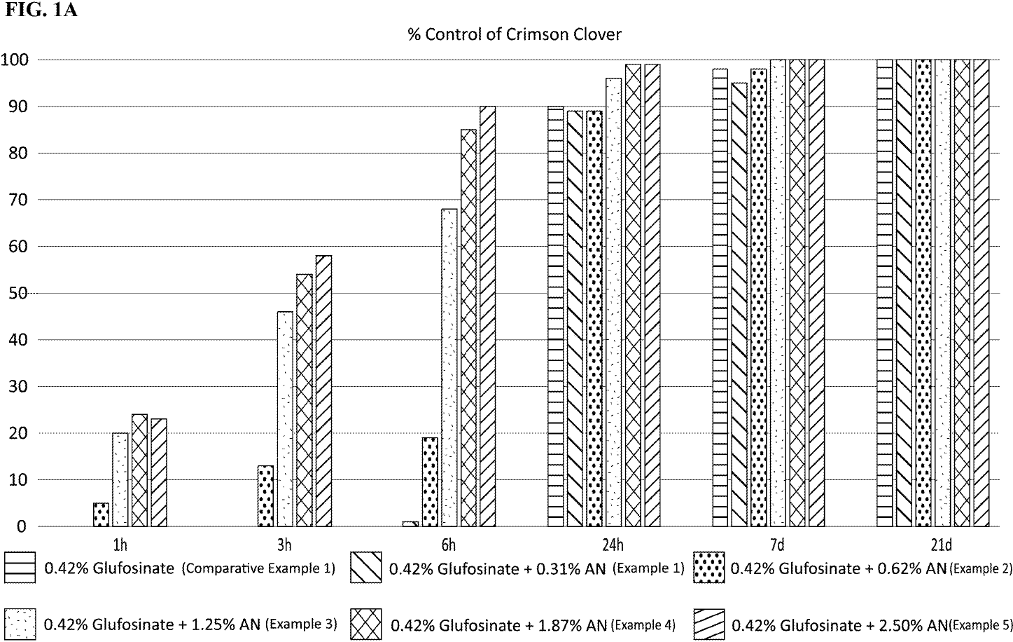

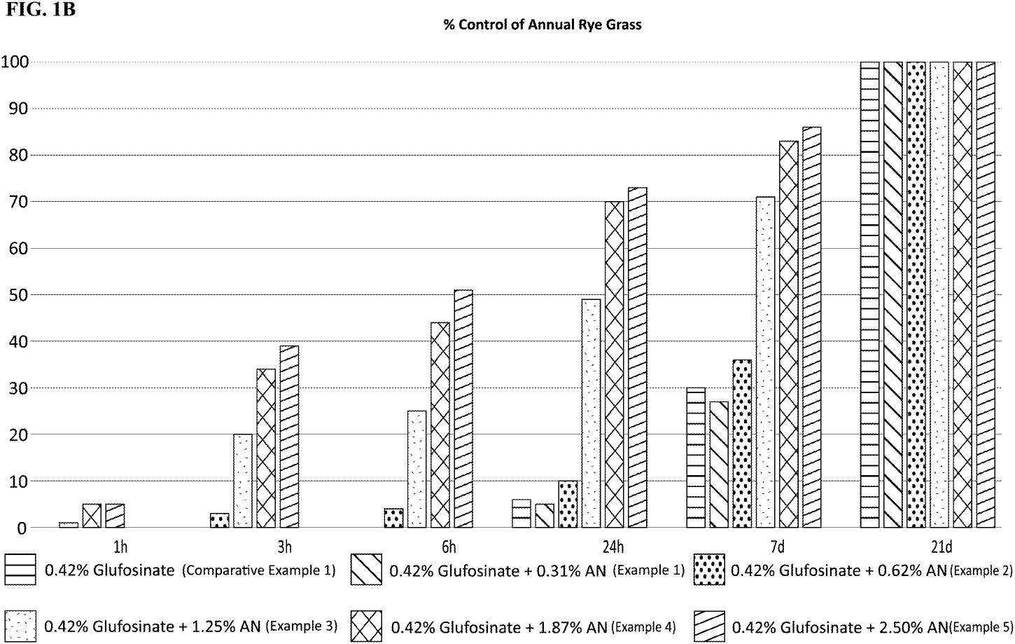

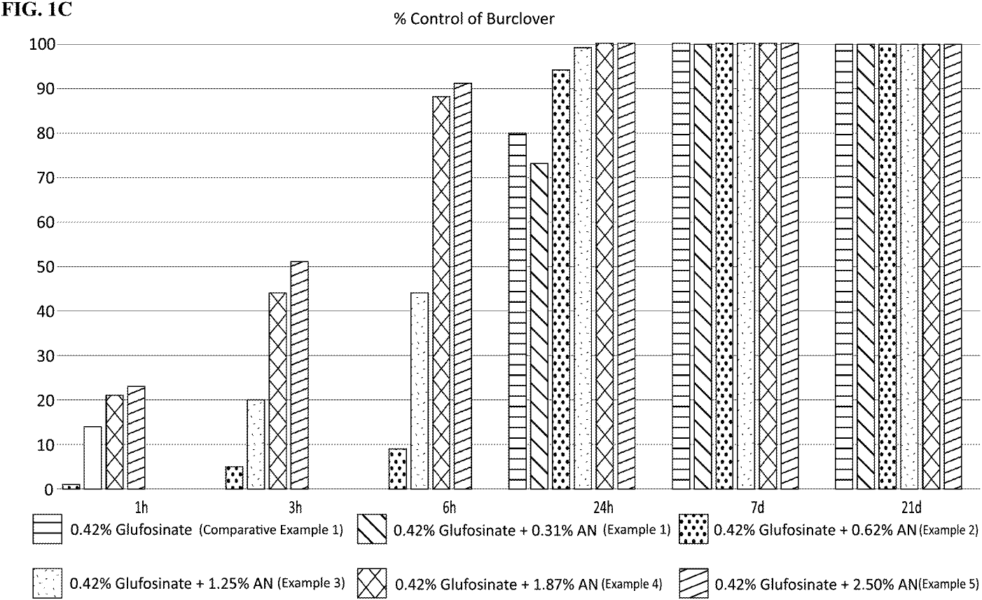

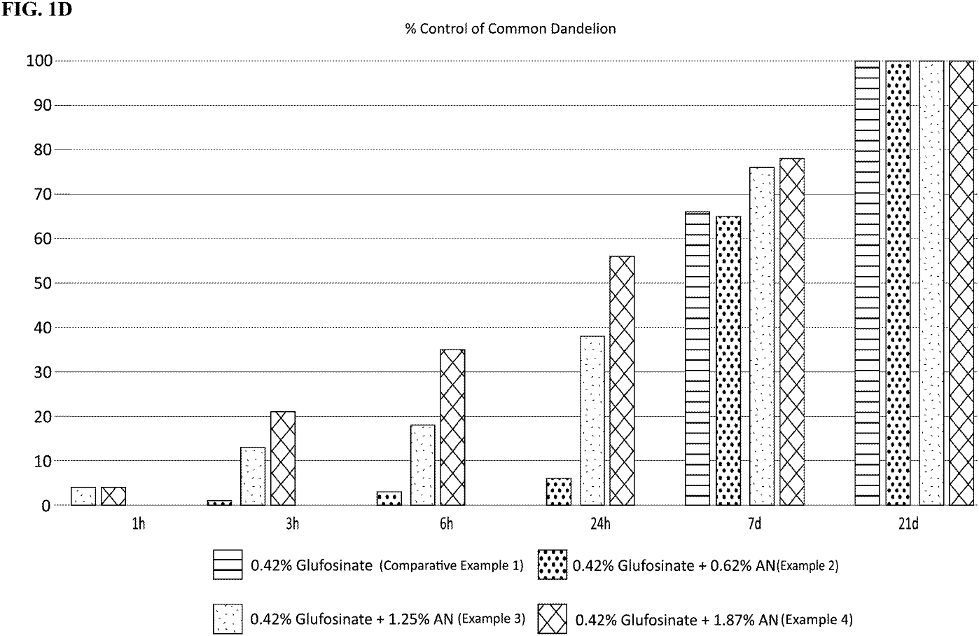

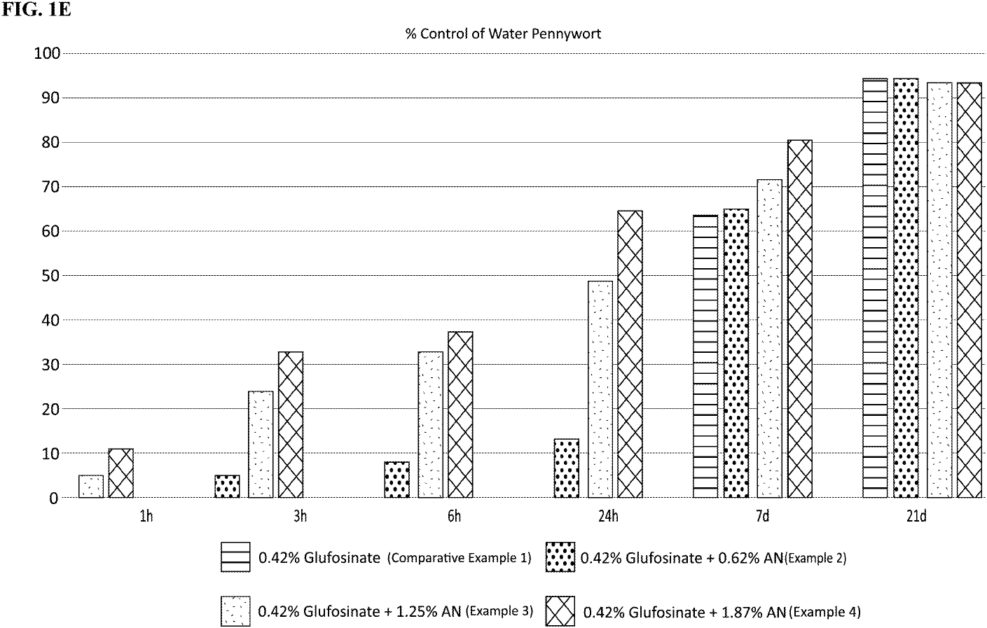

The field experiment results for various examples according to Table 2 are provided in FIGS. 1A-8D. FIGS. 1A-1E show the early burndown efficiency and herbicidal efficacy results for Examples 1-5 each having glufosinate and ammonium nonanoate as the burndown agent as compared to control composition (Comparative Example 1) having only glufosinate without ammonium nonanoate. It was observed that Examples 1-5 all caused early burndown symptoms such as yellowing, browning, wilting, and a reliable sign indicative of plant injury for all five tested weeds and grasses (Crimson Clover, Annual Rye Grass, Burclover, Common Dandelion, Water Pennywort) within 1 hour after application. The burndown symptoms remained visible and indicative of plant injury. The herbicidal efficacy (% control) gradually increased after treatment and reached up to about 60% control after 3 hours and up to about 100% after 6 hours. Examples 3-5 with relatively high concentration of ammonium nonanoate (about 1.25 wt% to about 2.5 wt%) were found to be more effective on the early burndown symptomology as compared with Examples 1-2 having lower concentrations of ammonium nonanoate as well as the control composition without ammonium nonanoate. However, it is noted that too much ammonium nonanoate (e.g., higher than 2.5 wt% or so) might provide too much initial burndown symptomology, which could lead to decreased absorption of the glufosinate and undermine the long-term residual control efficacy and overall herbicidal efficacy.

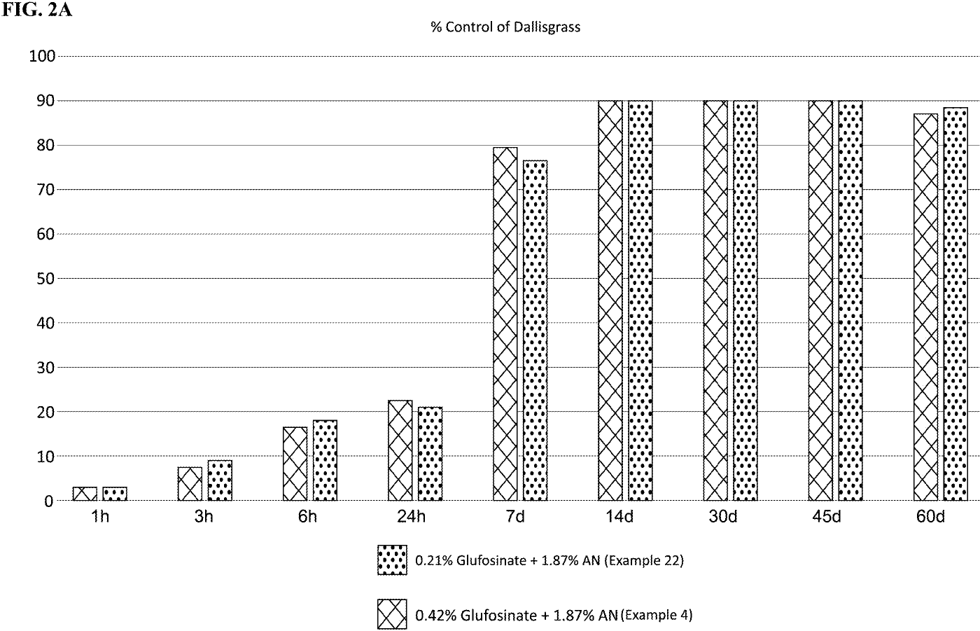

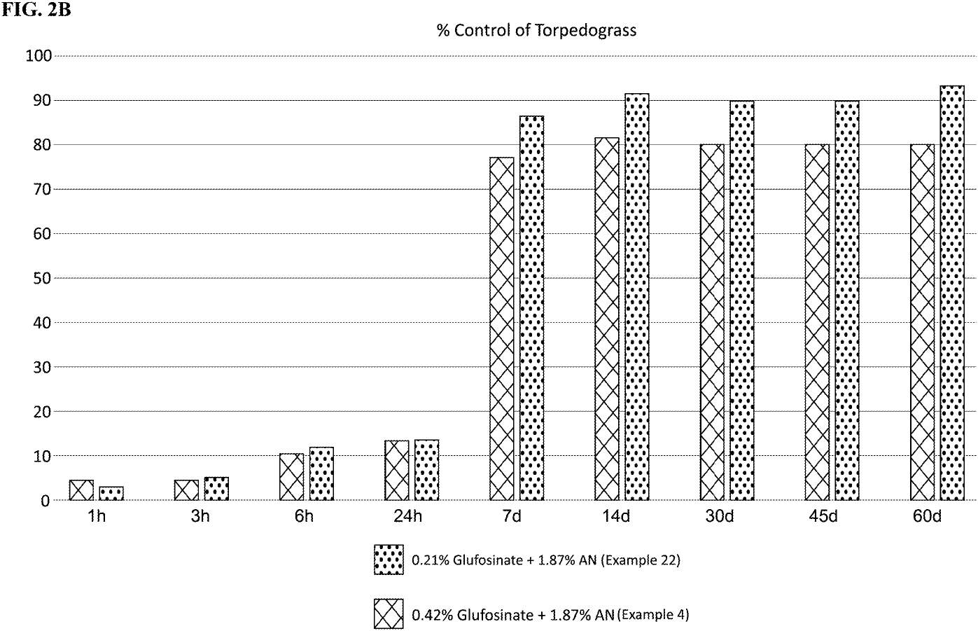

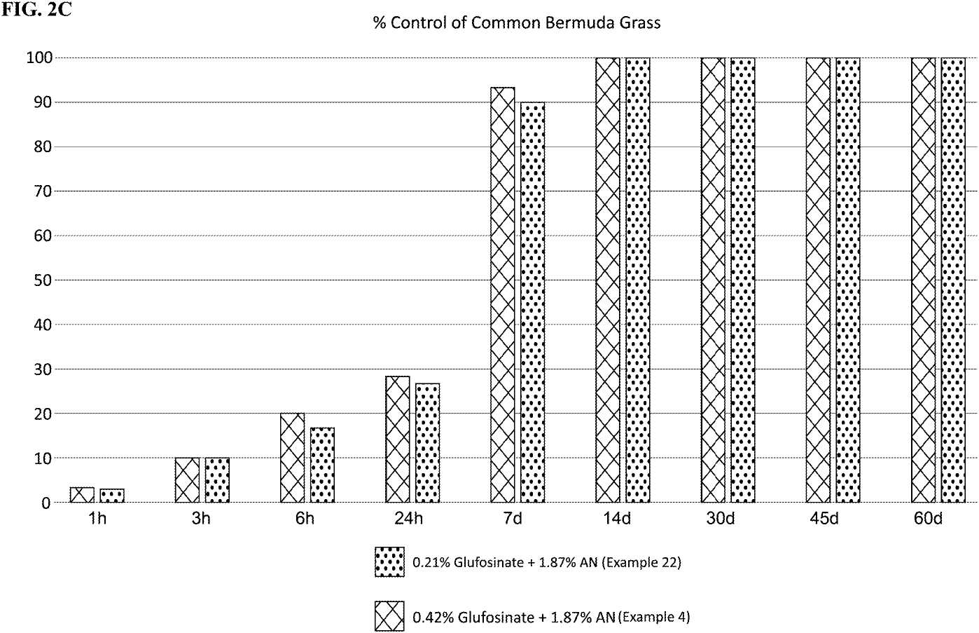

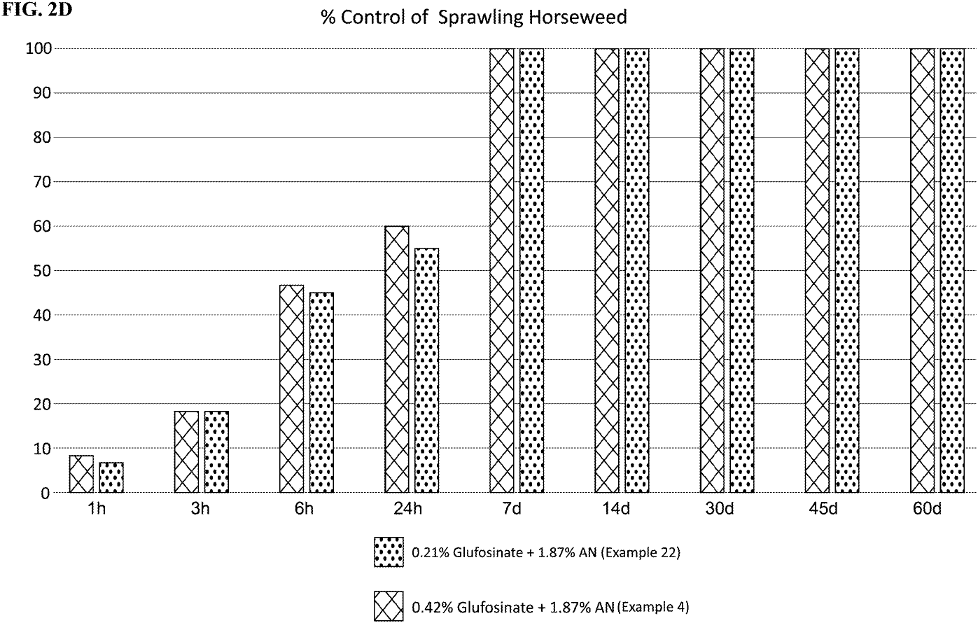

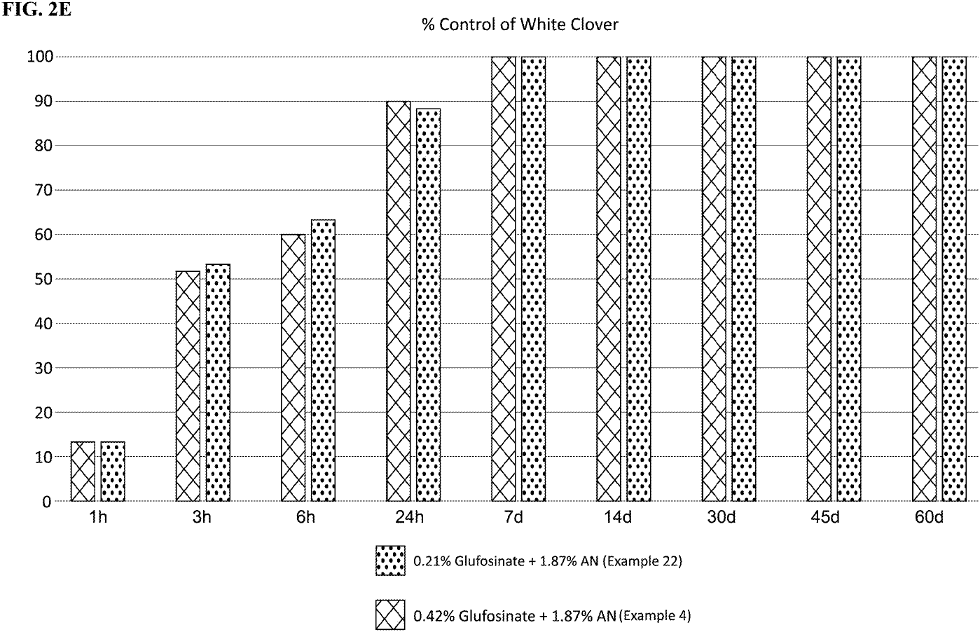

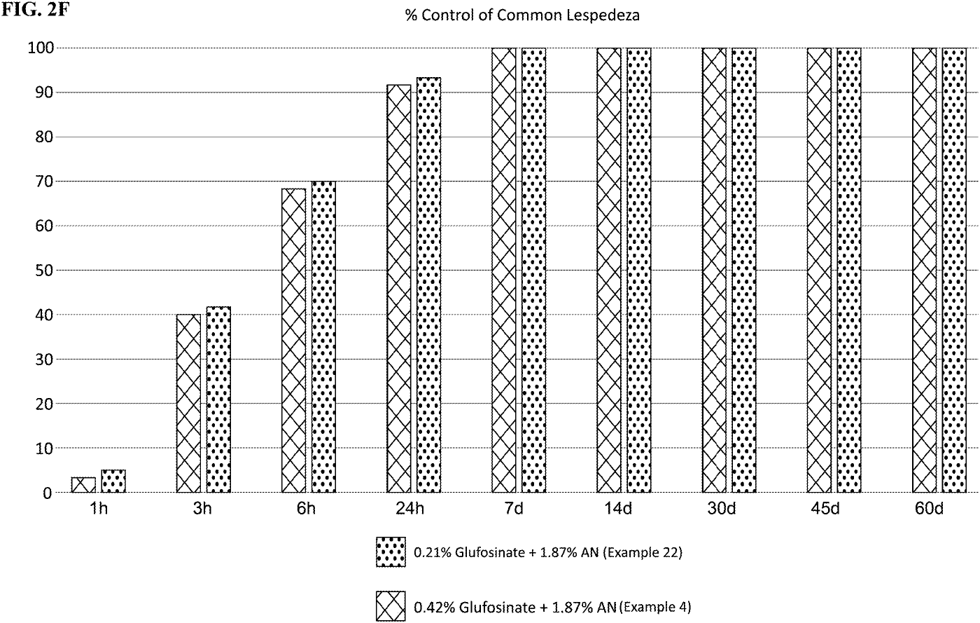

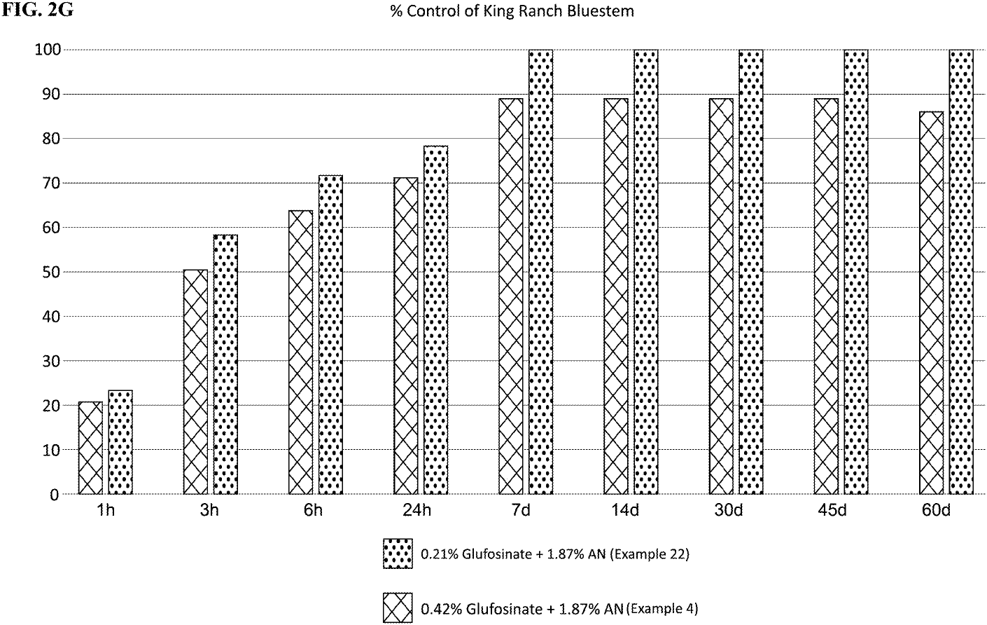

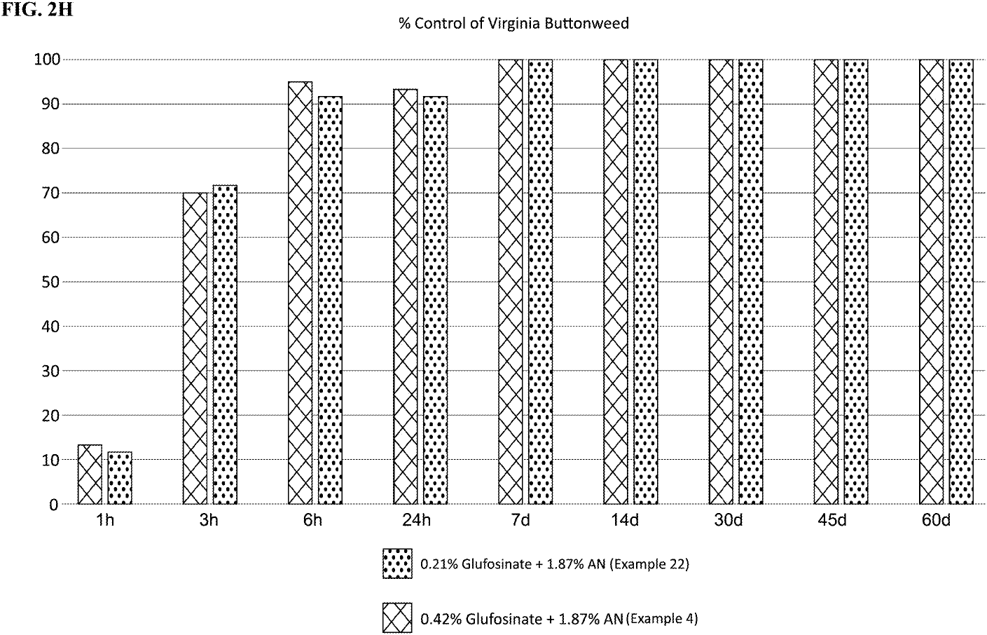

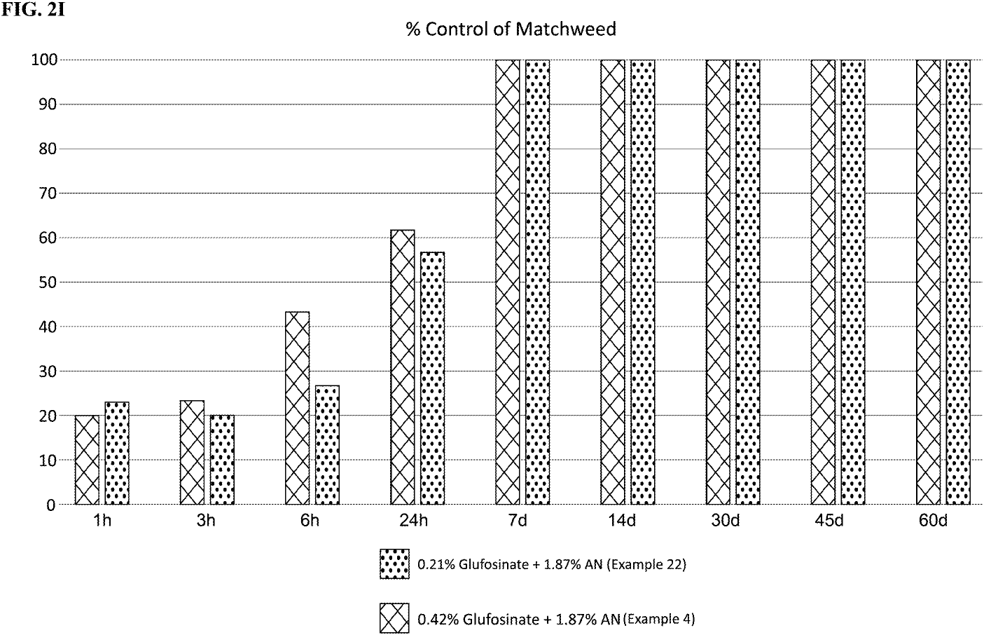

Likewise, FIGS. 2A-2I show the early burndown efficiency and herbicidal efficacy results for Example 4 and Example 22 each having glufosinate and ammonium nonanoate. It was observed that both caused early burndown symptoms as described above for all 8 tested weeds and grasses (Dallisgrass, Torpedograss, Bermudagrass, Carpetgrass, King Ranch Bluestem, Sprawling Horseweed, White Clover, Common Lespedeza, Virginia Buttonweed, and Matchweed) within 1 hour after application and remained visible thereafter. A reduction in the level of glufosinate is shown to have comparable efficacy to previously described formulations found in FIGS. 1A-1E. In these examples, glufosinate levels were compared at two levels, 0.42 wt% and 0.21 wt%, while ammonium nonanoate was maintained in the formulations at 1.87 wt%. The results support herbicidal efficacy and early burndown symptomology despite a reduction in glufosinate concentration.

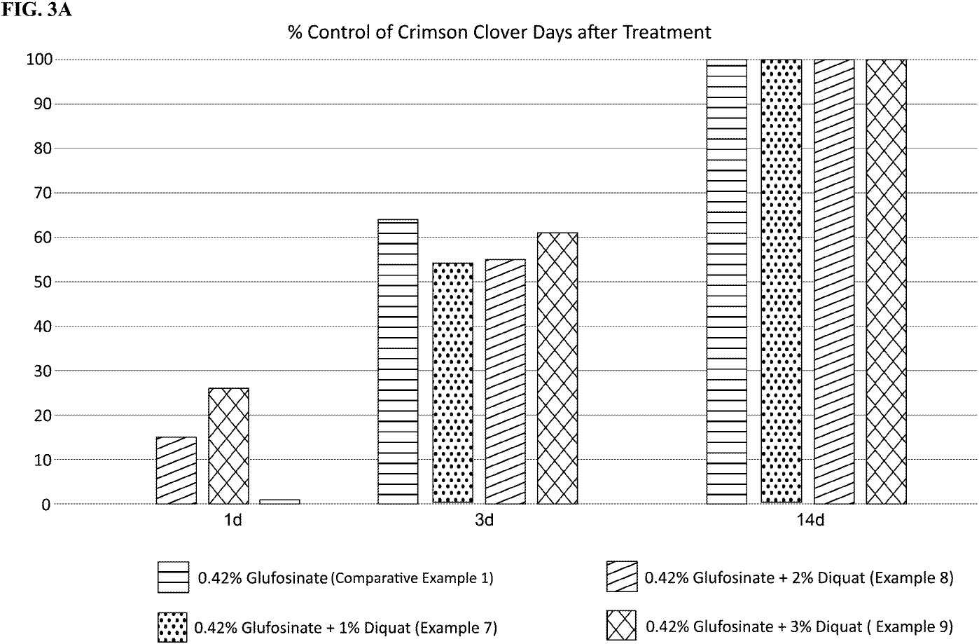

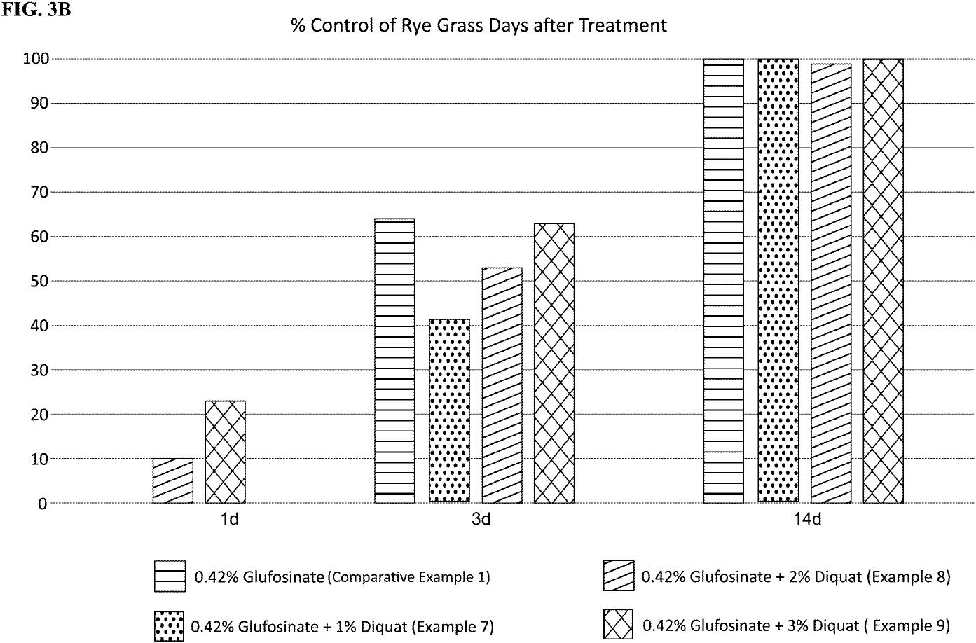

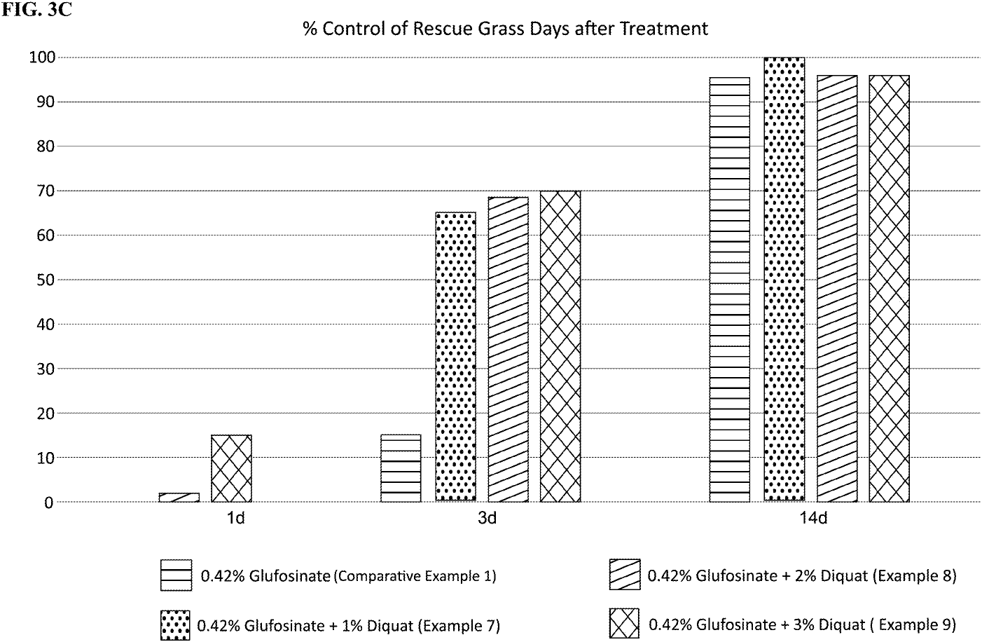

Likewise, FIGS. 3A-3C show the early burndown efficiency and herbicidal efficacy results for Examples 7-9 each having glufosinate and diquat as the burndown agent as compared to control composition (Comparative Example 1) having only glufosinate without diquat. Examples 8-9 having 2 wt%-3 wt% diquat provided initial symptomology within one day after application. The burndown symptoms remained visible and indicative of plant injury, and the herbicidal efficacy gradually increased and reached up to about 60% in 3 days and up to about 100% in 14 days after application for all three types of weeds (Crimson Clover, Annual Rye Grass, Rescue Grass) tested in the field experiments. While both showed enhanced burndown compared to glufosinate alone, ammonium nonanoate provided superior effectiveness compared to Diquat. These results support t herbicidal efficacy and early burndown symptomology of the present compositions.

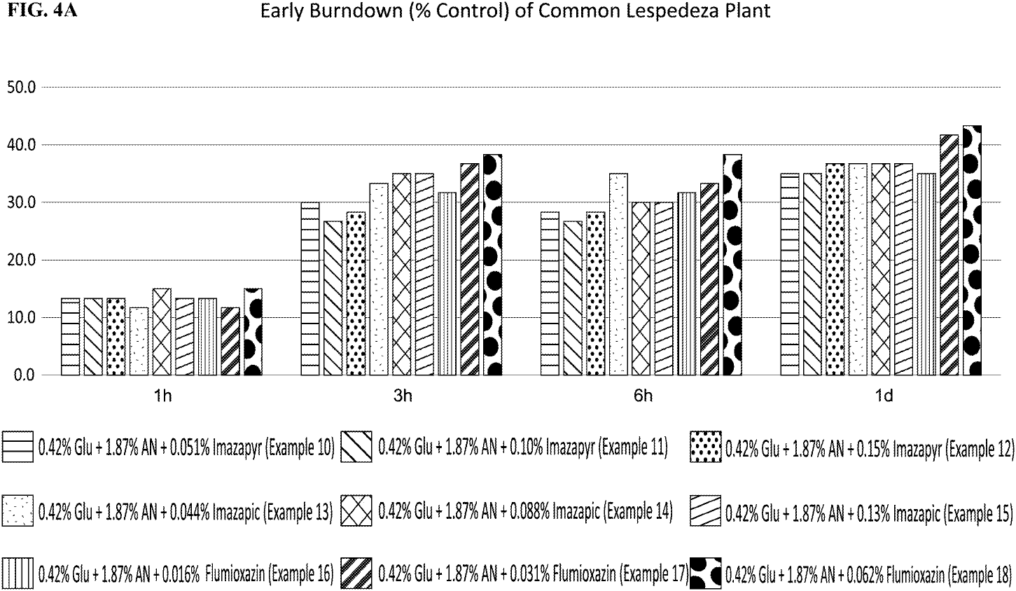

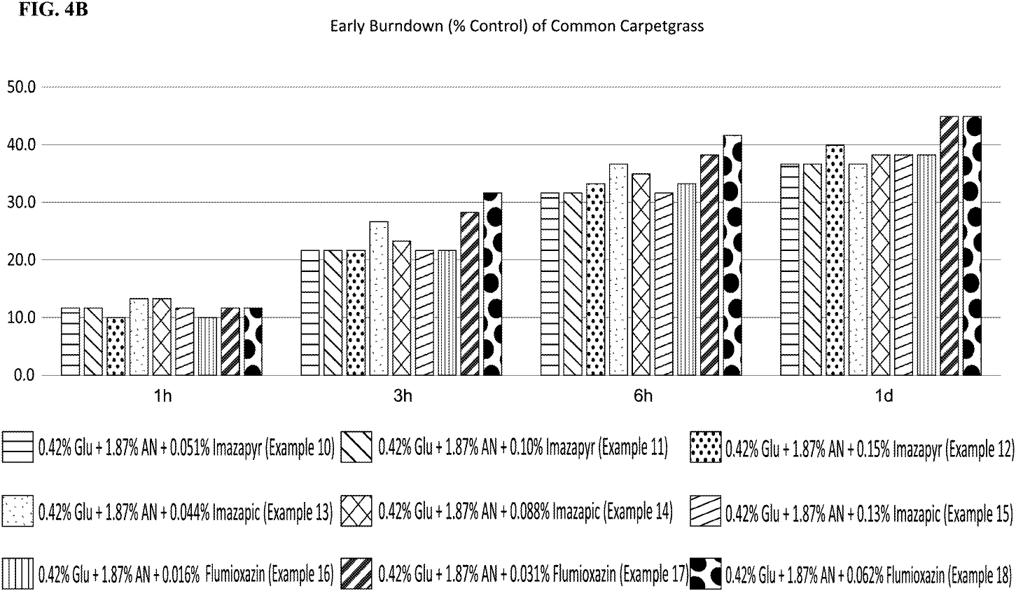

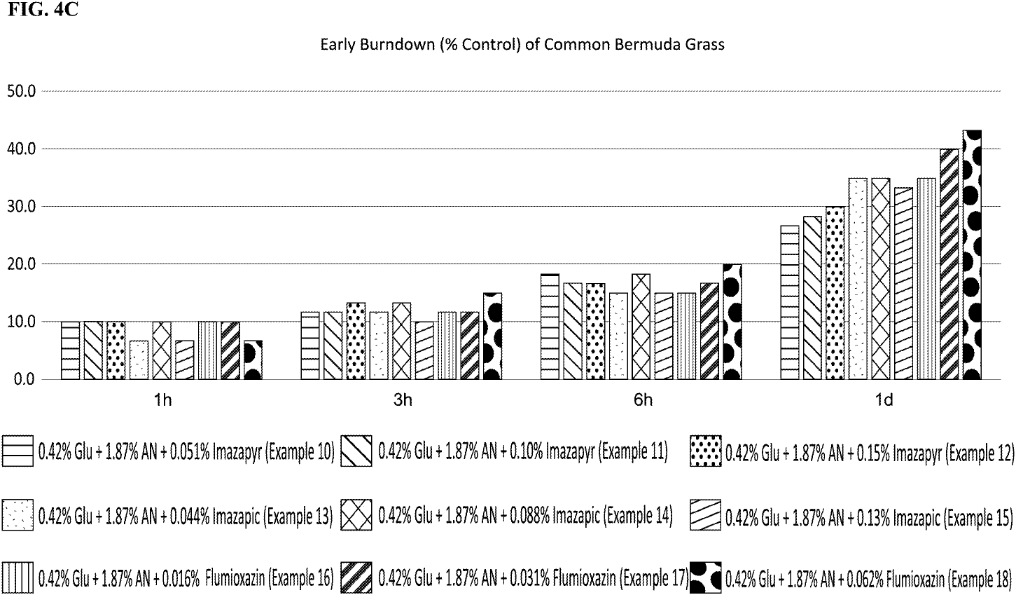

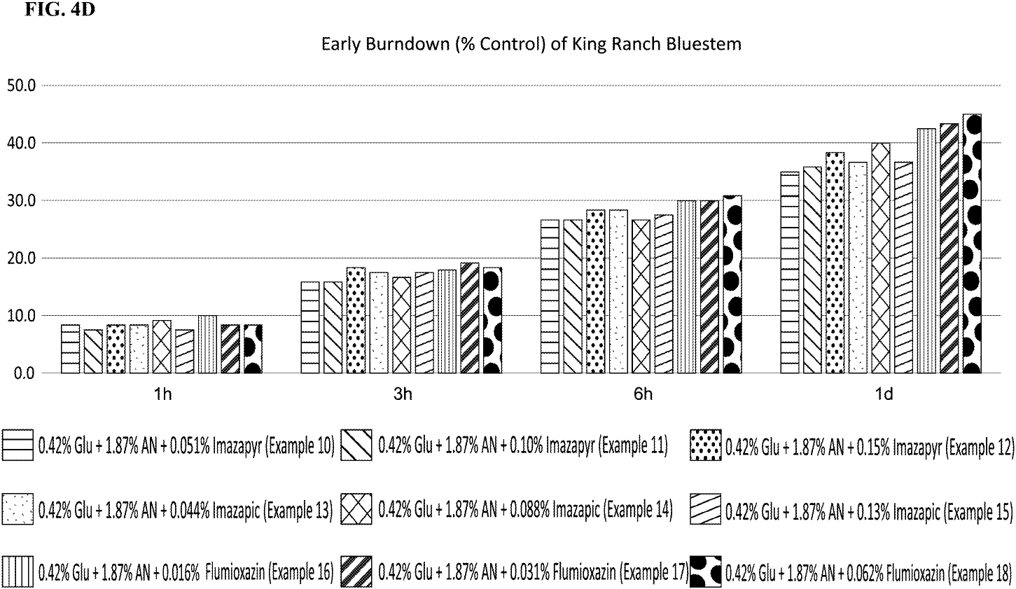

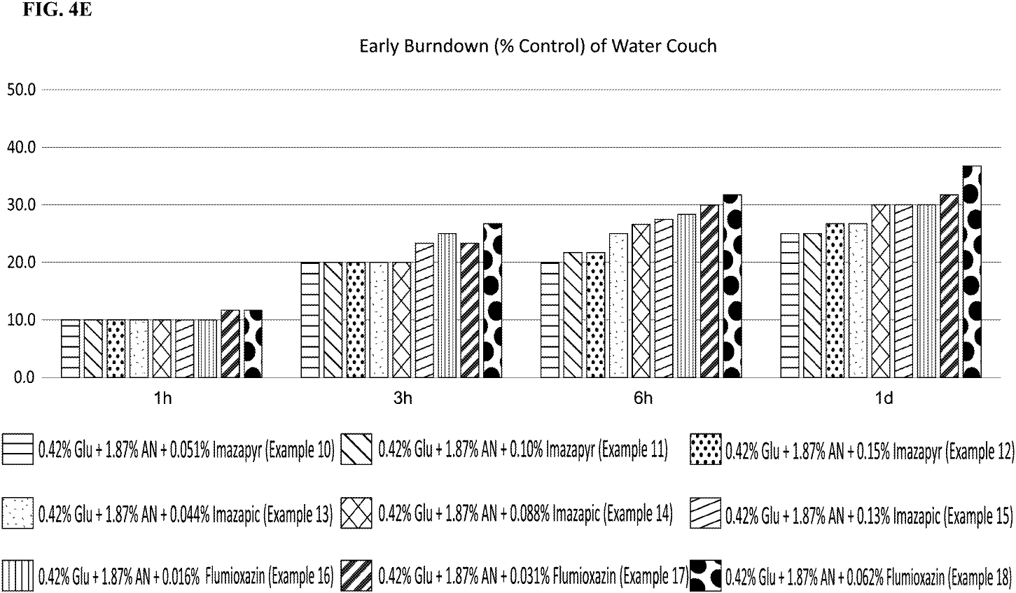

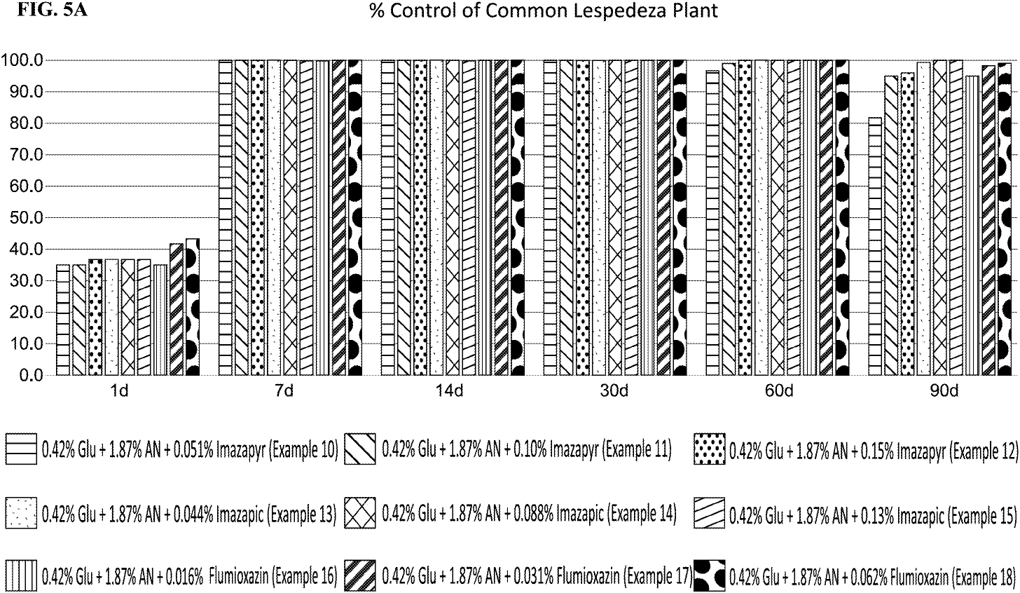

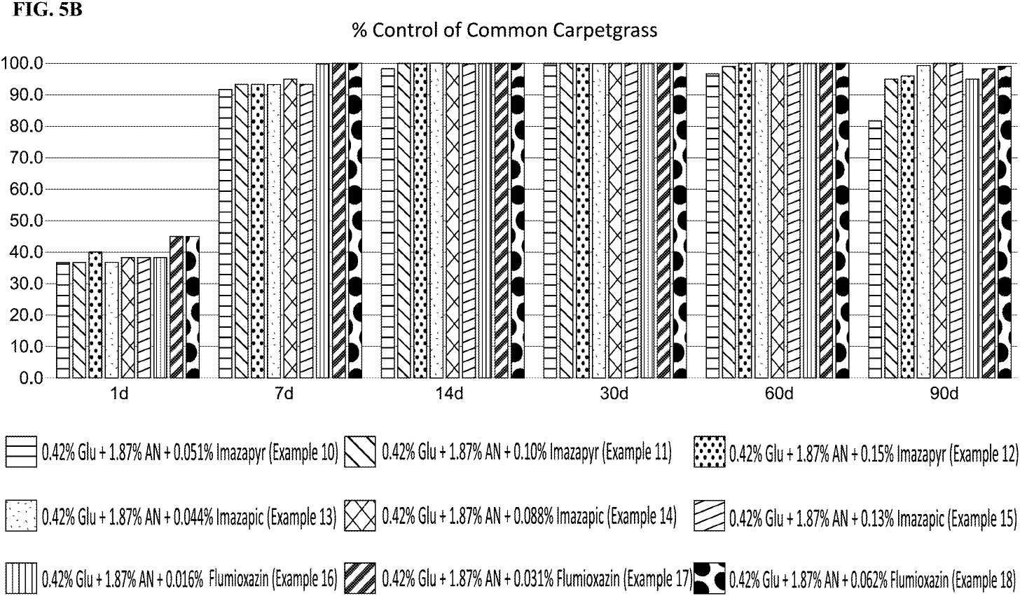

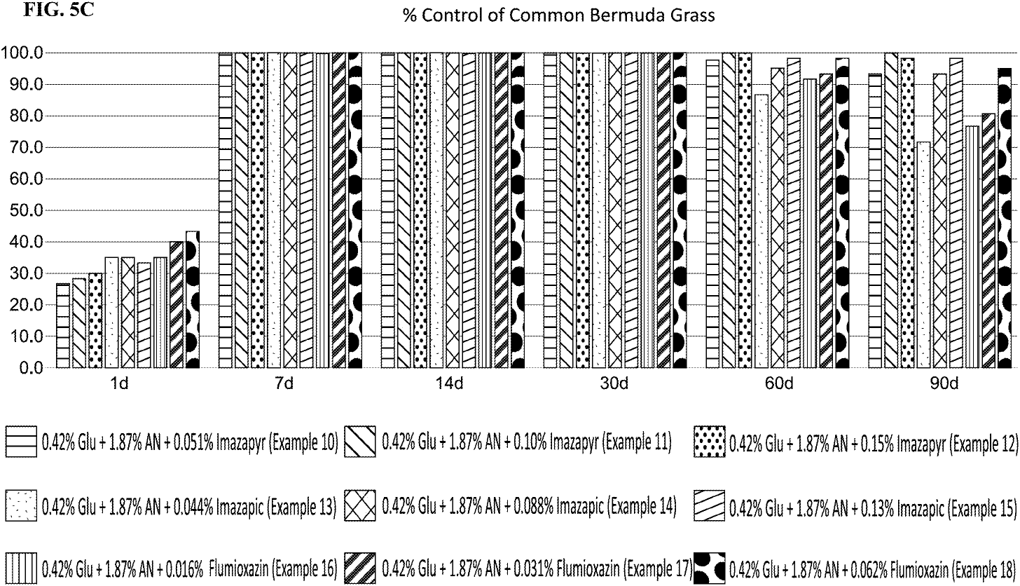

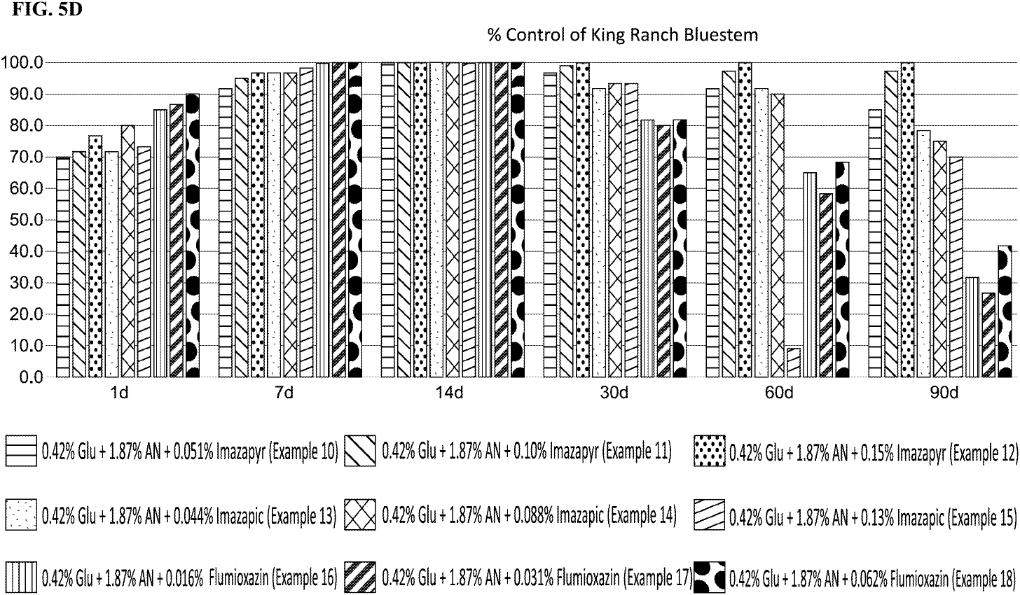

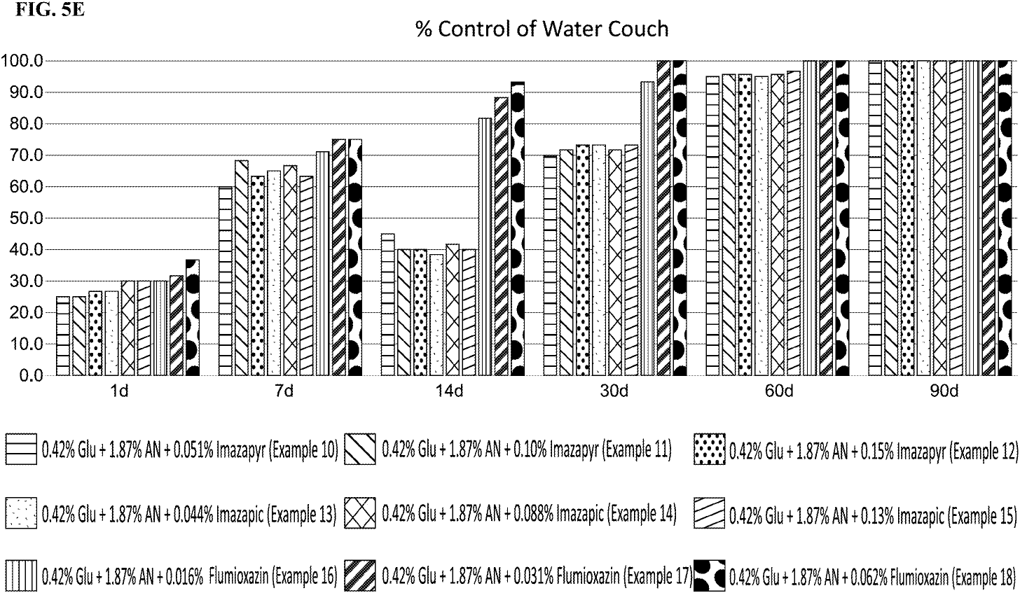

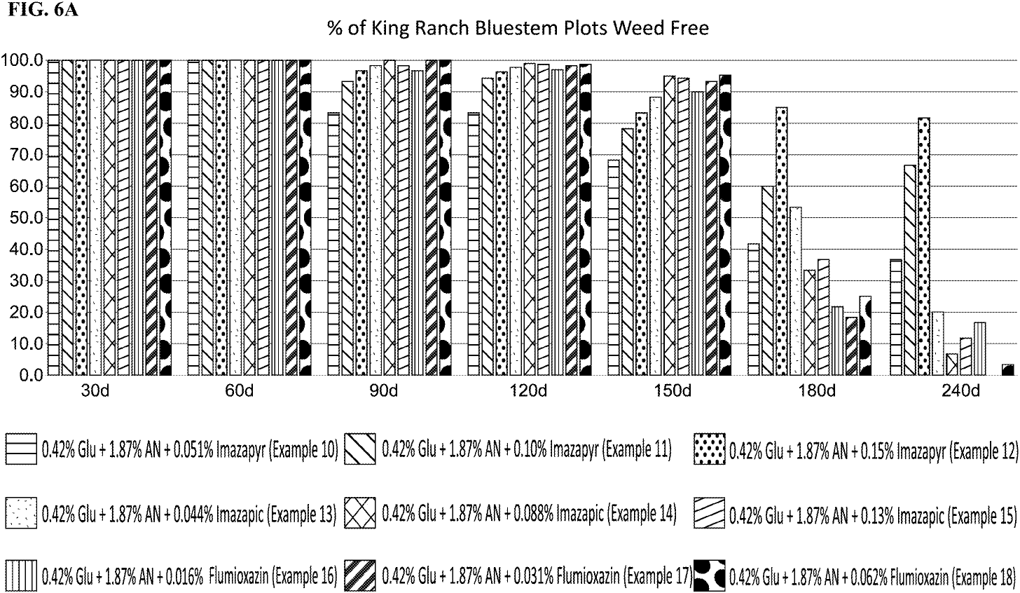

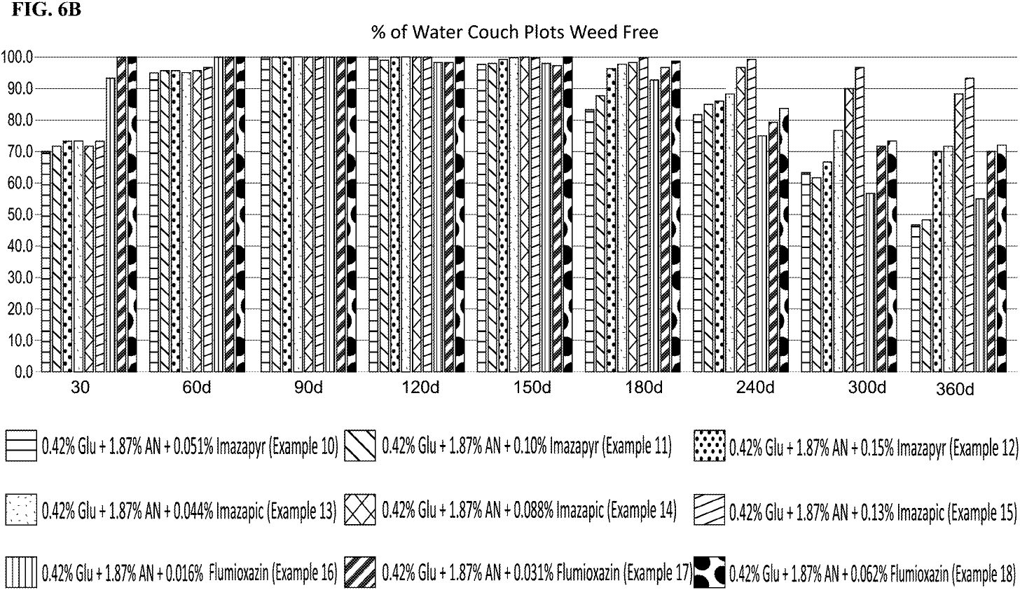

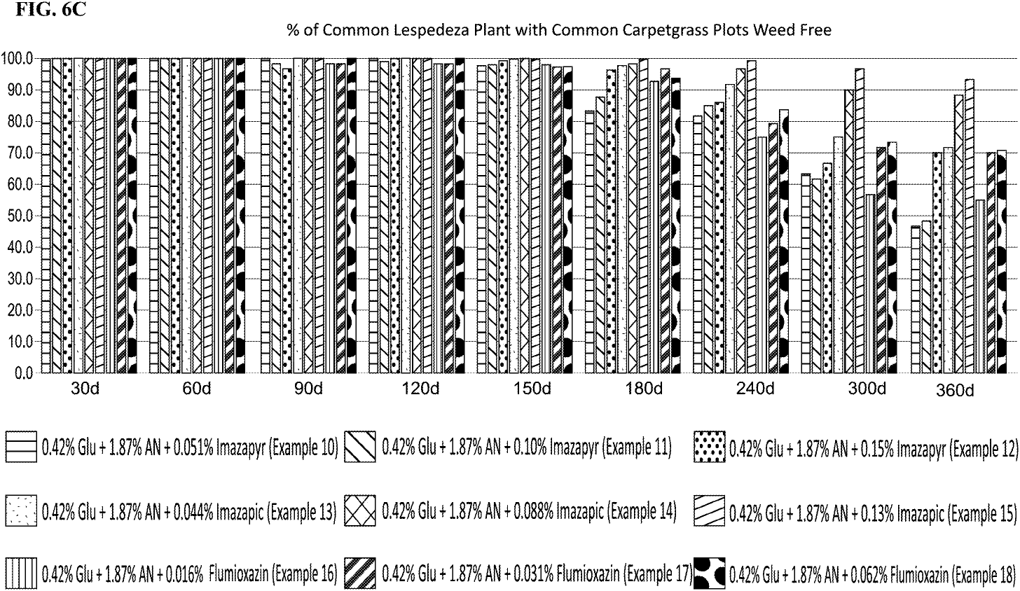

FIGS. 4A-4E and FIGS. 5A-5E respectively and correspondingly show the early burndown efficiency and herbicidal efficacy results for the five types of weeds and grasses (Common Lespedeza Plant, Common Carpetgrass, Common Bermuda Grass, King Ranch Bluestem, Water Couch) treated in the field experiments. Examples 10-18 each comprises glufosinate, ammonium nonanoate, and a residual control active agent selected from imazapic, imazapyr, and flumioxazin. As shown in FIGS. 4A-4E, all example compositions provided early burndown symptomology within 1 hour, and the total herbicidal efficacy was found to increase significantly within 6 hours. As shown in FIGS. 5A-5E, the herbicidal efficacy could extend to 30 days, 60 days, and 90 days, with overall control higher than 90% for most tested weeds. FIGS. 6A-6C show the residual pre-emergent efficacy of Examples 10-18 for the control of three representative weed plots, King Ranch Bluestem, Water Couch, and Common Lespedeza Plant with Common Carpetgrass. Apparently, the weed-free area of the treated plot remained almost 100% from day 30 to day 90 after application, with little-to-no germination of new weeds from the weed seed bank. These treated areas remained weed free, at above 80% rating, for 90 days, 120 days, 150 days, 180 days, 240 days, 300 days, and 360 days depending upon active ingredient combination, active ingredient concentration, and weed tested. These results support the excellent long term herbicidal efficacy, excellent long-term residual control activity, and efficient early burndown symptomology of the present compositions based on the combination of glufosinate, the residual control active agent (imazapic or imazapyr or flumioxazin), and the burndown agent (ammonium nonanoate or diquat).

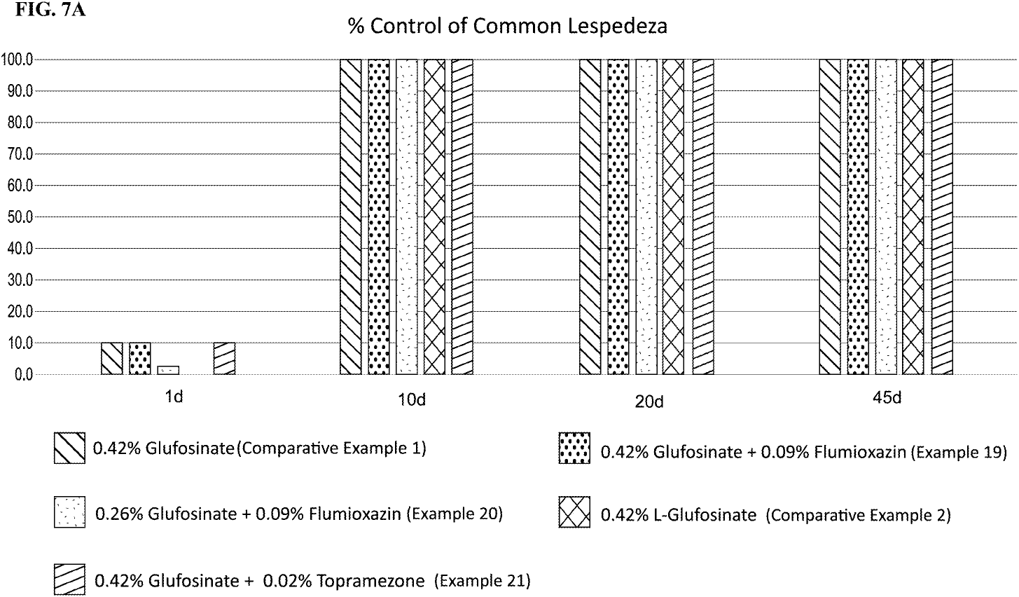

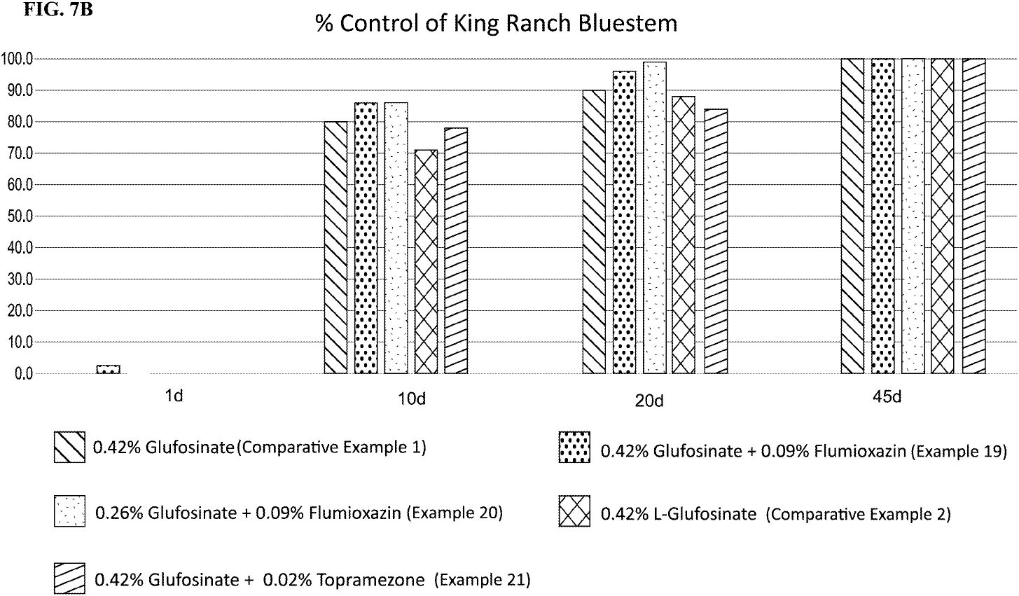

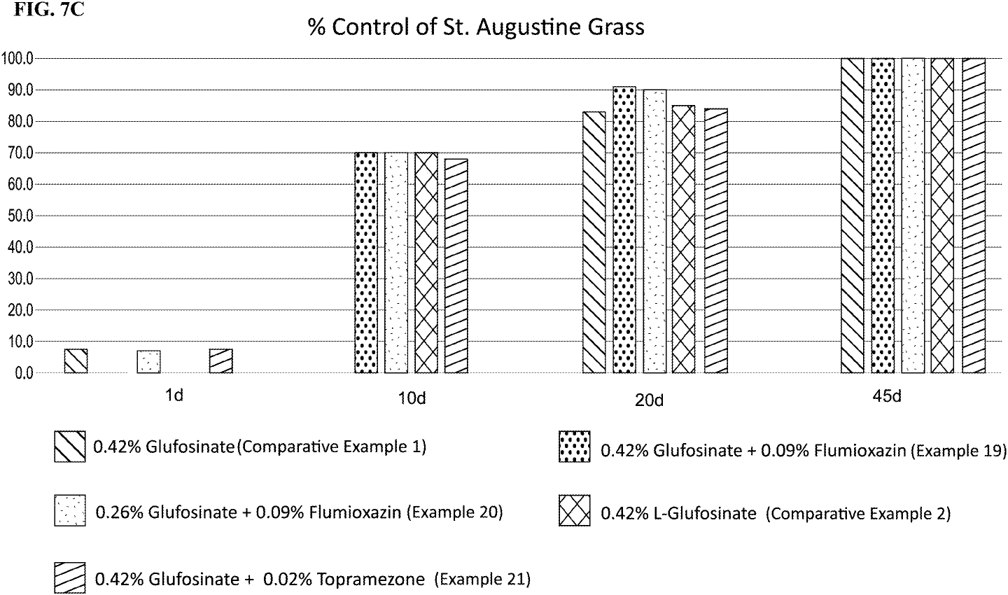

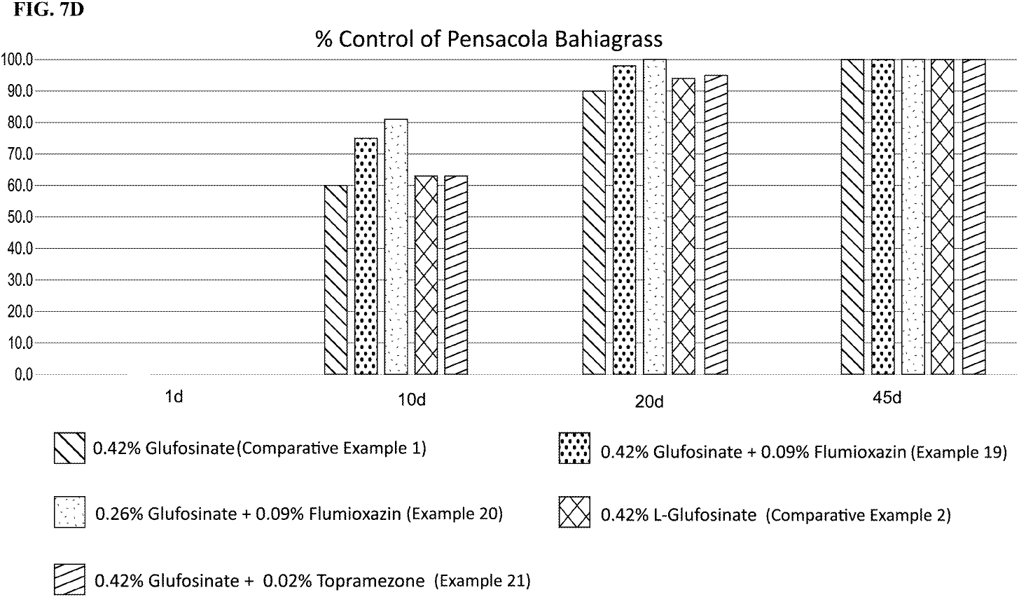

FIGS. 7A-7D respectively show the herbicidal efficacy results (% control) extended to 45 days after application of Examples 19-21 and Comparative Examples 1-2 for the control of four different types of weeds/grass. Examples 19-20 have glufosinate and flumioxazin as the residual control active agent; Example 21 has glufosinate and topramezone as the residual control active agent. As compared with the Comparative Examples 1 and 2 without any residual control active agent, Examples 19-20 are shown to have better % control on day 10 and day 20 for King Ranch Bluestem, St. Augustine Grass, and Pensacola Bahiagrass.

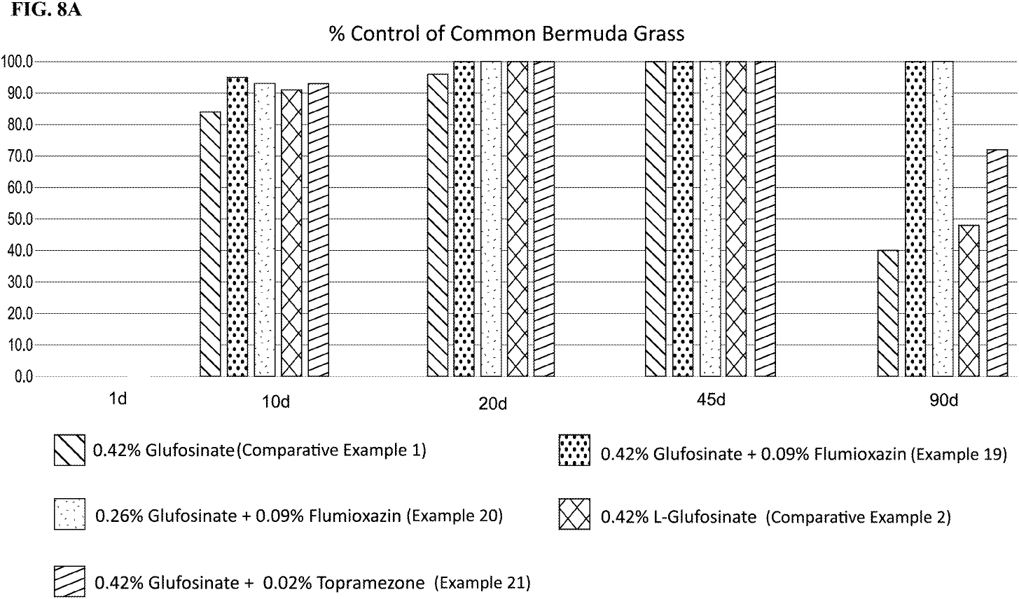

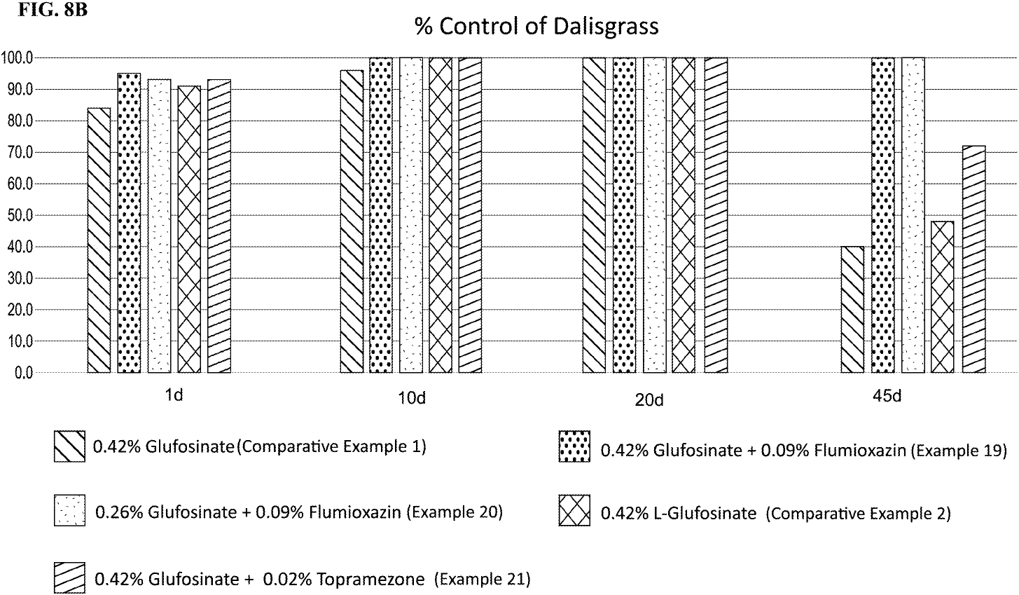

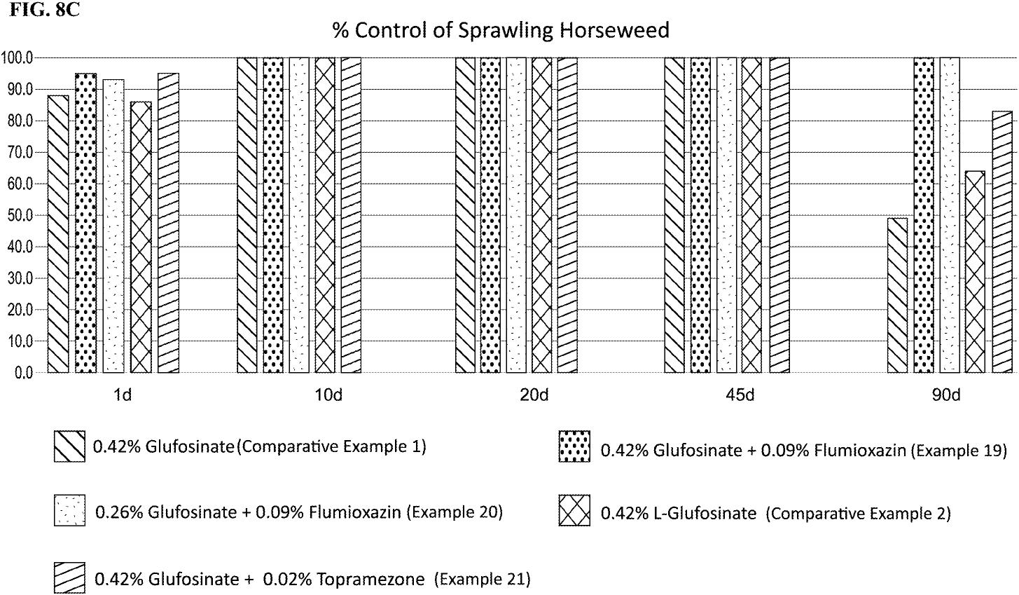

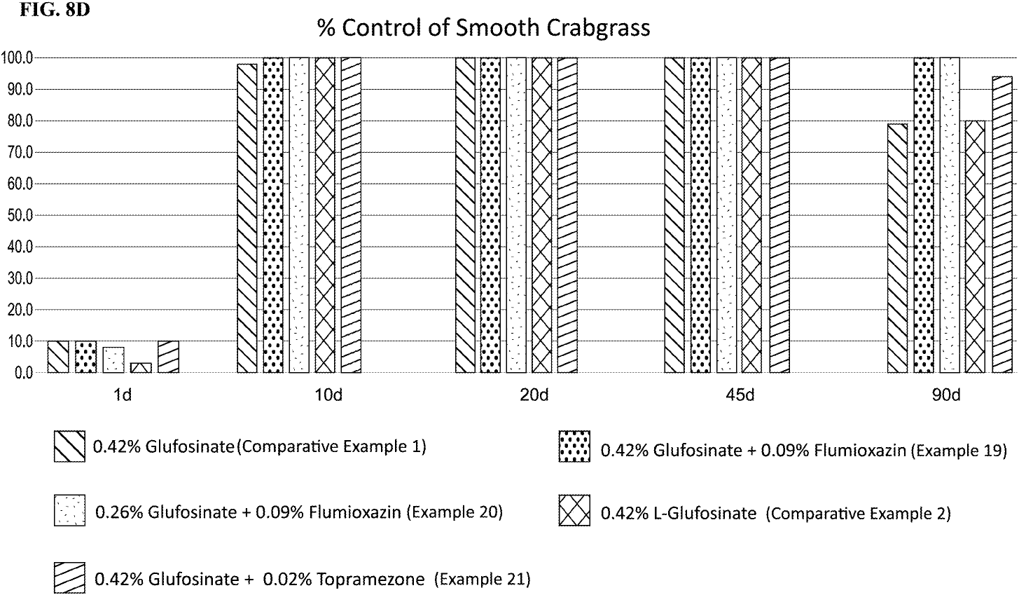

FIGS. 8A-8D respectively show the herbicidal efficacy results (% control) extended to 90 days after application of Examples 19-21 and Comparative Examples 1-2 for the control of four different types of weed/grass. As compared with the Comparative Examples 1 and 2 without any residual control active agent, Examples 19-20 are shown to have significantly improved herbicidal efficacy (up to 100% control) even 90 days after application, for all four types of tested annual and perennial weeds and grasses. Additionally, it can be noted in Example 20 that a reduction in Glufosinate concentration can achieve these same results (100% Control at 90-days post- application) when combined with Flumioxazin, further supporting the enhancement noted above. These results further support the residual control efficacy of the present compositions having glufosinate and flumioxazin or topramezone or their analogues.

### NUMBERED CLAUSES

The following numbered clauses define further example aspects and features of the compositions, methods, and techniques of the present disclosure:

1. A non-selective herbicide composition for control of annual and perennial grasses and broadleaf weeds, comprising:
a post-emergent herbicidal active agent;
a residual control active agent; and
a burndown agent.

2. The composition of clause 1, further comprising a carrier selected from water, an organic solvent, a buffer solution, an emulsion, or combinations thereof.

3. The composition of any one of clauses 1-2, wherein the post-emergent herbicidal active agent comprises glufosinate or a salt or derivative thereof.

4. The composition of clause 3, wherein the glufosinate is in a form of an enantiomeric mixture, or in a form of L-glufosinate.

5. The composition of any one of clauses 1-4, wherein the residual control active agent is a pre-emergent herbicide active agent.

6. The composition of any one of clauses 1-5, wherein the residual control active agent comprises at least one of a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof.

7. The composition of clause 6, wherein,
the PPO inhibitor is selected from acifluorfen, azafeniden, bifenox, carfentrazone-ethyl, flumioxazin, flumiclorac-pentyl, fluthiacet-methyl, fomesafen, ipfencarbazone, lactofen, oxadiargyl, oxadiazon, oxyfluorfen, pentoxazone, pyraclonil, pyraflufen-ethyl, saflufenacil, tiafenacil, or derivatives thereof, or any combinations thereof; and
the ALS/ALHS inhibitor is selected from imazapic, imazapyr, imazethapyr, or derivatives thereof, or any combinations thereof.
the 4-HPPD inhibitor is selected from topramezone, mesotrione, or derivatives thereof, or a combination thereof.

8. The composition of any one of clauses 1-7, wherein the burndown agent comprises at least one of: a fatty acid compound, or an organic dication compound such as a diquat compound, or any combinations thereof.

9. The composition of clause 8, wherein the fatty acid compound is a fatty acid salt comprising:
a C₆ to C₁₉, or C₇ to C₁₁, or C₈ to C₁₀ hydrocarbyl group optionally substituted with a hydroxyl or a C₁-C₅ hydrocarbyl group;
an ammonium, an alkali metal, an alkaline earth metal, or any combinations thereof.

10. The composition of clause 9, wherein the burndown agent is selected from ammonium nonanoate, alkali nonanoate, alkaline earth nonanoate, ammonium decanoate, alkali decanoate, alkaline earth decanoate, or any combinations thereof.

11. The composition of any one of clauses 1-10, wherein composition has a weight ratio of the post-emergent herbicidal active agent to the residual control active agent from about 2,000:1 to about 1:100, from about 1,000:1 to about 1:10, from about 500:1 to about 1:1, from about 100:1 to about 1:1, from about 50:1 to about 1:1, from about 10:1 to about 1:1, from about 8:1 to about 1:1, from about 5:1 to about 1:1.

12. The composition of any one of clauses 1-11, wherein the composition has a weight ratio of the post-emergent herbicidal active agent to the burndown agent from about 100:1 to about 1:100, from about 50:1 to about 1:50, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1.

13. The composition of any one of clauses 1-12, wherein the composition has a weight ratio of the residual control active agent to the burndown agent from about 100:1 to about 1:500, from about 10:1 to about 1:200, from about 1:1 to about 1:200, from about 1:1 to about 1:150, from about 1:1 to about 1:100, from about 1:1 to about 1:60, from about 1:5 to about 1:30, from about 1:10 to about 1:200, from about 1:10 to about 150, from about 1:10 to about 1:100, from about 1:10 to about 1:50, from about 1:10 to about 1:40, from about 1:10 to about 1:30, or from about 1:15 to about 1:50, or from about 1:35 to about 1:150.

14. The composition of any one of clauses 1-13, further comprising a functional ingredient selected from an additional herbicidal active ingredient, a surfactant, an emulsifier, a dispersing agent, a stabilizer, a foam-moderating agent, a preservative, an anti-freeze agents, a solubility-enhancing agent, a dye or pigment, a pH modifier, a thickening agent, a fragrance, an adjuvant, an excipient, a fertilizer, a rainfast agent, or any combinations thereof.

15. The composition of any one of clauses 1-14, wherein the post-emergent herbicidal active agent has a concentration of about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition.

16. The composition of any one of clauses 1-15, wherein the residual control active agent has a concentration of about 0.001 wt% to about 10 wt%, from about 0.05 wt% to about 5 wt%, from about 0.1 wt% to about 5 wt%, from about 0.5 wt% to about 2 wt%, based on the total weight of the composition.

17. The composition of any one of clauses 1-16, wherein the burndown agent has a concentration of about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition.

18. The composition of any one of clauses 1-17, wherein the composition is a ready-to-use (RTU) solution.

19. The composition of clause 18, wherein the RTU solution has a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution.

20. The composition of any one of clauses 18-19, wherein the RTU solution has a concentration of the or residual control active agent from about 0.001 wt% to about 1 wt%, from about 0.005 wt% to about 0.5 wt%, from about 0.01 wt% to about 0.05 wt%, based on the total weight of the RTU solution.

21. The composition of any one of clauses 18-20, wherein the RTU solution has a concentration of the burndown agent from about 0.1 wt% to about 20 wt%, from about 0.5 wt% to about 10 wt%, from about 1 wt% to about 5 wt%, based on the total weight of the RTU solution.

22. The composition of any one of clauses 18-21, wherein the RTU solution is packaged in a spray container.

23. The composition of any one of clauses 18-22, wherein the composition has a form selected from a liquid, powder, tablet, granule, or dried concentrate.

24. A non-selective herbicide composition, comprising:
from about 0.01 wt% to about 20 wt% of a post-emergent herbicidal active agent selected from glufosinate or a salt or derivative thereof;
from about 0.001 wt% to about 10 wt% of a residual control active agent comprising a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof;
from about 0.05 wt% to about 50 wt% of a burndown agent comprising a fatty acid compound, or an organic dication compound such as diquat dibromide, or any combinations thereof; and
a carrier,
wherein the composition has a weight ratio of the post-emergent herbicidal active agent to the residual control active agent from about 100:1 to about 1:1,
wherein the composition has a weight ratio of the post-emergent herbicidal active agent to the burndown agent from about 5:1 to about 1:5.

25. The composition of clause 24, wherein,
the PPO inhibitor comprises flumioxazin;
the 4-HPPD inhibitor comprises topramezone; and
the ALS/ALHS inhibitor comprises at least one of imazapic, imazapyr, imazethapyr, or any combinations thereof.

26. The composition of any one of clauses 24-25, wherein the post-emergent herbicidal active agent is glufosinate and the residual control active agent is flumioxazin, and wherein the weight ratio of glufosinate to flumioxazin is about 30:1 or less, about 24:1 or less, about 10:1 or less, about 8:1 or less, or about 5:1 or less.

27. The composition of any one of clauses 24-26, wherein the burndown agent is selected from ammonium nonanoate, alkali nonanoate, alkaline earth nonanoate, or any combinations thereof.

28. The composition of any one of clauses 24-27, wherein the composition has a weight ratio of the residual control active agent to the burndown agent from about 1:1 to about 1:150, from about 1:1 to about 1:100, from about 1:1 to about 1:60, from about 1:5 to about 1:30, from about 1:10 to about 1:30, from about 1:10 to about 150, from about 1:10 to about 1:100, from about 1:10 to about 1:50, from about 1:10 to about 1:40, or from about 1:15 to about 1:50, or from about 1:35 to about 1:150.

29. A non-selective herbicide RTU composition, comprising:
from about 0.1 wt% to about 0.5 wt% of glufosinate or a salt or derivative thereof;
from about 0.01 wt% to about 0.1 wt% of flumioxazin;
from about 1 wt% to about 5 wt% of ammonium nonanoate; and
water,
wherein the composition has a weight ratio of glufosinate to flumioxazin about 24:1 or less, 10:1 or less, or 5:1 or less,
wherein the composition has a weight ratio of glufosinate to ammonium nonanoate about 1:10 or less,
wherein the composition has a weight ratio of flumioxazin to ammonium nonanoate about 1:5 or less, 1:10 or less, about 1:35 or less, about 1:100 or less.

30. A non-selective herbicide RTU composition, comprising:
from about 0.1 wt% to about 0.5 wt% of glufosinate or a salt or derivative thereof;
from about 0.01 wt% to about 0.1 wt% of flumioxazin;
from about 1 wt% to about 5 wt% of a diquat compound; and
water,
wherein the composition has a weight ratio of glufosinate to flumioxazin about 24:1 or less, 10:1 or less, or 5:1 or less,
wherein the composition has a weight ratio of glufosinate to diquat compound about 1:10 or less,
wherein the composition has a weight ratio of flumioxazin to diquat compound about 1:10 or less.

31. A non-selective herbicide RTU composition, comprising:
from about 0.1 wt% to about 0.5 wt% of glufosinate or a salt or derivative thereof;
from about 0.01 wt% to about 0.05 wt% of an ALS/ALHS inhibitor selected from imazapic, imazapyr, imazethapyr, or derivatives thereof, or any combinations thereof;
from about 1 wt% to about 5 wt% of a burndown agent selected from ammonium nonanoate, a diquat compound, or both; and
water,
wherein the composition has a weight ratio of glufosinate to the ALS/ALHS inhibitor about 10:1 or less,
wherein the composition has a weight ratio of glufosinate to the burndown agent about 1:10 or less,
wherein the composition has a weight ratio of the ALS/ALHS inhibitor to the burndown agent about 1:10 or less.

32. A non-selective herbicide RTU composition, comprising:
from about 0.1 wt% to about 0.5 wt% of glufosinate or a salt or derivative thereof;
from about 0.01 wt% to about 0.05 wt% of topramezone;
from about 1 wt% to about 5 wt% of a burndown agent selected from ammonium nonanoate, a diquat compound, or both; and
water,
wherein the composition has a weight ratio of glufosinate to topramezone about 10:1 or less,
wherein the composition has a weight ratio of glufosinate to the burndown agent about 1:10 or less,
wherein the composition has a weight ratio of topramezone to the burndown agent about 1:10 or less.

33. The composition of any one of clauses 1-32, wherein application of the composition to an area in need of weed control causes early burndown symptoms (yellowing, wilting, browning, necrosis) of weeds or undesired plants after about 30 minutes to about 6 hours, or about 1 hour to about 3 hours.

34. The composition of any one of clauses 1-33, wherein application of the composition to an area in need of weed control causes long-term control efficacy and remains effective for at least 15 days, at least 45 days, at least 60 days, at least 90 days, at least 120 days, at least 150 days, at least 180 days, at least 210 days, at least 240 days, at least 270 days, at least 300 days, or at least 360 days, or 1 year (365/6 days).

35. The composition of any one of clauses 33-34, wherein the area is a landscape edge, a non-crop area around farmsteads, building foundation, a shelter belt, a fencerow, a driveway, a sidewalk, a paver patio, a gravel area, an area under deck, a parking area, a walkway, and any unplanted area where no weeds are desired.

36. The composition of any one of clauses 1-35, wherein the composition is effective to control a weed or grass selected from common annual broadleaf weeds, common perennial broadleaf weeds, common annual grasses, common perennial grasses, or any combinations thereof.

37. A method for control of annual and perennial grass and broadleaf weeds, comprising applying a non-selective herbicide composition according to any one of clauses 1-36 to an area in need thereof.

38. The method of clause 37, further comprising:

applying a maintenance composition, the maintenance composition comprising a herbicidally active agent selected from a post-emergent herbicidal active agent, a residual control active agent, a burndown agent, or any combinations thereof.

39. The method of any one of clauses 37-38, wherein the post-emergent herbicidal active agent comprises glufosinate or a salt or derivative thereof.

40. The method of any one of clauses 37-39, wherein the residual control active agent comprises at least one of a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof.

41. The method of any one of clauses 38-40, wherein the maintenance composition is applied at least 15 days, at least 30 days, at least 45 days, at least 60 days, at least 90 days, at least 120 days after applying the non-selective herbicide composition.

42. The method of any one of clauses 37-41, wherein applying the non-selective herbicide composition comprises spraying the non-selective herbicide composition stored in a spray container to the area.

43. The method of any one of clauses 37-42, wherein the non-selective herbicide composition has rainfast property after application.

44. A non-selective herbicide composition for control of annual and perennial grasses and broadleaf weeds, comprising:
a post-emergent herbicidal active agent; and
a burndown agent.

45. The composition of clause 44, further comprising a carrier selected from water, an organic solvent, a buffer solution, an emulsion, or combinations thereof.

46. The composition of any one of clauses 44-45, wherein the post-emergent herbicidal active agent comprises glufosinate or a salt or derivative thereof.

47. The composition of any one of clauses 44-46, wherein the glufosinate is in a form of an enantiomeric mixture, or in a form of L-glufosinate.

48. The composition of any one of clauses 44-47, wherein the burndown agent comprises at least one of: a fatty acid compound, or an organic dication compound such as a diquat compound, or any combinations thereof.

49. The composition of clause 48, wherein the fatty acid compound is a fatty acid salt comprising:
a C₆ to C₁₉, or C₇ to C₁₁, or C₈ to C₁₀ hydrocarbyl group optionally substituted with a hydroxyl or a C₁-C₅ hydrocarbyl group;
an ammonium, an alkali metal, an alkaline earth metal, or any combinations thereof.

50. The composition of clause 49, wherein the burndown agent is selected from ammonium nonanoate, alkali nonanoate, alkaline earth nonanoate, ammonium decanoate, alkali decanoate, alkaline earth decanoate, or any combinations thereof.

51. The composition of any one of clauses 44-50, wherein the composition has a ratio of post-emergent herbicidal active agent to the burndown agent from about 100:1 to about 1:100, from about 50:1 to about 1:50, from about 10:1 to about 1:10, from about 5:1 to about 1:5, from about 4:1 to about 1:4, from about 3:1 to about 1:3, from about 2:1 to about 1:2, from about 1:1 to about 1:5, from about 1:7 to about 1:1, from about 1:10 to about 1:1, or from about 1:20 to about 1:1.

52. The composition of any one of clauses 44-51, further comprising a functional ingredient selected from an additional herbicidal active ingredient, a surfactant, an emulsifier, a dispersing agent, a stabilizer, a foam-moderating agent, a preservative, an anti-freeze agents, a solubility-enhancing agent, a dye or colorant, a pH modifier, a thickening agent, a fragrance, an adjuvant, an excipient, a fertilizer, a rainfast agent, or any combinations thereof.

53. The composition of any one of clauses 44-52, wherein the post-emergent herbicidal active agent has a concentration of about 0.01 wt% to about 20 wt%, from about 0.05 wt% to about 10 wt%, from about 0.1 wt% to about 10 wt%, from about 1 wt% to about 10 wt%, or from about 1 wt% to about 6 wt%, based on the total weight of the composition.

54. The composition of any one of clauses 44-53, wherein the burndown agent has a concentration of about 0.05 wt% to about 50 wt%, from about 0.1 wt% to about 40 wt%, from about 0.5 wt% to about 50 wt%, from about 1 wt% to about 30 wt%, or from about 1 wt% to about 10 wt%, or from about 1 wt% to about 5 wt%, based on the total weight of the composition.

55. The composition of any one of clauses 44-54, wherein the composition is a ready-to-use (RTU) solution.

56. The composition of clause 55, wherein the RTU solution has a concentration of the post-emergent herbicidal active agent from about 0.01 wt% to about 3 wt%, from about 0.05 wt% to about 1 wt%, from about 0.1 wt% to about 0.5 wt%, based on the total weight of the RTU solution.

57. The composition of any one of clauses 55-56, wherein the RTU solution has a concentration of the burndown agent from about 0.1 wt% to about 20 wt%, from about 0.5 wt% to about 10 wt%, from about 1 wt% to about 5 wt%, based on the total weight of the RTU solution.

58. A non-selective herbicide composition, comprising:
from about 0.01 wt% to about 20 wt% of a post-emergent herbicidal active agent selected from glufosinate or a salt or derivative thereof;
from about 0.05 wt% to about 50 wt% of a burndown agent comprising a fatty acid compound, or an organic dication compound such as diquat dibromide, or any combinations thereof; and
a carrier,
wherein the composition has a weight ratio of the post-emergent herbicidal active agent to the burndown agent from about 10:1 to about 1:10.

59. The composition of clause 58, wherein the burndown agent is a fatty acid salt comprising:
a C₆ to C₁₉, or C₇ to C₁₁, or C₈ to C₁₀ hydrocarbyl group optionally substituted with a hydroxyl or a C₁-C₅ hydrocarbyl group;
an ammonium, an alkali metal, an alkaline earth metal, or any combinations thereof.

60. The composition of any one of clauses 58-59, wherein the burndown agent is selected from ammonium nonanoate, alkali nonanoate, alkaline earth nonanoate, or any combinations thereof.

61. A non-selective herbicide RTU composition, comprising:
from about 0.1 wt% to about 0.5 wt% of glufosinate or a salt or derivative thereof;
from about 1 wt% to about 5 wt% of a burndown agent selected from ammonium nonanoate, a diquat compound, or both; and
water,
wherein the composition has a weight ratio of glufosinate to the burndown agent of about 200:1 to about 1:200.

62. A non-selective herbicide RTU composition, comprising:
from about 0.1 wt% to about 0.5 wt% of glufosinate or a salt or derivative thereof;
from about 1 wt% to about 5 wt% of ammonium nonanoate; and
water,
wherein the composition has a weight ratio of glufosinate to the ammonium nonanoate of about 1:10 to about 1:100.

63. A non-selective herbicide RTU composition, comprising:
from about 0.1 wt% to about 0.5 wt% of glufosinate or a salt or derivative thereof;
from about 1 wt% to about 5 wt% of a diquat compound; and
water,
wherein the composition has a weight ratio of glufosinate to the diquat compound of about 1:1 to about 1:20.

64. The composition of any one of clauses 44-63, wherein application of the composition to an area in need of weed control causes early burndown symptoms of weeds or undesired plants in the area.

65. The composition of any one of clauses 44-64, wherein application of the composition to the area causes long-term control efficacy and remains effective for at least 15 days, at least 45 days, or at least 60 days.

66. The composition of any one of clauses 64-65, wherein the area a landscape edge, a non-crop area around farmsteads, building foundation, a shelter belt, a fencerow, a driveway, a sidewalk, a paver patio, a gravel area, an area under deck, a parking area, a walkway, and any unplanted area where no weeds are desired.

67. The composition of any one of clauses 44-66, wherein the composition is effective to control a weed selected from common annual broadleaf weed, common perennial broadleaf weed, common annual grasses, common perennial grasses, or any combinations thereof.

68. A method for control of annual and perennial grasses and broadleaf weeds, comprising applying a non-selective herbicide composition according to any one of clauses 44-67 to an area in need thereof.

69. The method of clause 68, further comprising:

applying a maintenance composition, the maintenance composition comprising a herbicidally active compound selected from a post-emergent herbicidal active agent, a residual control active agent, a burndown agent, or any combinations thereof.

70. The method of clause 69, wherein the post-emergent herbicidal active agent comprises glufosinate or a salt or derivative thereof.

71. The method of any one of clauses 69-70, wherein the maintenance composition is applied at least 15 days, at least 30 days, at least 45 days, or at least 60 days, after applying the non-selective herbicide composition.

72. The method of any one of clauses 68-71, wherein applying the non-selective herbicide composition comprises spraying the non-selective herbicide composition stored in a spray container to the area.

73. The method of any one of clauses 68-72, wherein the non-selective herbicide composition has rainfast property after application.

74. The method of any one of clauses 68-73, wherein application of the non-selective herbicide composition causes early burndown symptoms after about 30 minutes to about 6 hours, or about 1 hour to about 3 hours.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

What is claimed is:

1. A non-selective herbicide composition for control of annual and perennial grasses and broadleaf weeds, comprising:
a post-emergent herbicidal active agent;
a residual control active agent; and
a burndown agent.

2. The composition of claim 1, further comprising a carrier selected from water, an organic solvent, a buffer solution, an emulsion, or combinations thereof.

3. The composition of claim 1, wherein the post-emergent herbicidal active agent comprises glufosinate or a salt or derivative thereof.

4. The composition of claim 3, wherein the glufosinate is in a form of an enantiomeric mixture, or in a form of L-glufosinate.

5. The composition of claim 1, wherein the residual control active agent is a pre-emergent herbicide active agent.

6. The composition of claim 1, wherein the residual control active agent comprises at least one of a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof.

7. The composition of claim 6, wherein,
the PPO inhibitor is selected from acifluorfen, azafeniden, bifenox, carfentrazone-ethyl, flumioxazin, flumiclorac-pentyl, fluthiacet-methyl, fomesafen, ipfencarbazone, lactofen, oxadiargyl, oxadiazon, oxyfluorfen, pentoxazone, pyraclonil, pyraflufen-ethyl, saflufenacil, tiafenacil, or derivatives thereof, or any combinations thereof; and
the ALS/ALHS inhibitor is selected from imazapic, imazapyr, imazethapyr, or derivatives thereof, or any combinations thereof.
the 4-HPPD inhibitor is selected from topramezone, mesotrione, or derivatives thereof, or a combination thereof.

8. The composition of claim 1, wherein the burndown agent comprises at least one of: a fatty acid compound, or an organic dication compound such as a diquat compound, or any combinations thereof.

9. The composition of claim 8, wherein the fatty acid compound is a fatty acid salt comprising:
a C₆ to C₁₉, or C₇ to C₁₁, or C₈ to C₁₀ hydrocarbyl group optionally substituted with a hydroxyl or a C₁-C₅ hydrocarbyl group;
an ammonium, an alkali metal, an alkaline earth metal, or any combinations thereof.

10. The composition of claim 9, wherein the burndown agent is selected from ammonium nonanoate, alkali nonanoate, alkaline earth nonanoate, ammonium decanoate, alkali decanoate, alkaline earth decanoate, or any combinations thereof.

11. The composition of claim 1, wherein composition has a weight ratio of the post-emergent herbicidal active agent to the residual control active agent from about 2,000:1 to about 1:100.

12. The composition of claim 1, wherein the composition has a weight ratio of the post-emergent herbicidal active agent to the burndown agent from about 100:1 to about 1:100.

13. The composition of claim 1, wherein the composition has a weight ratio of the residual control active agent to the burndown agent from about 100:1 to about 1:500.

14. The composition of claim 1, further comprising a functional ingredient selected from an additional herbicidal active ingredient, a surfactant, an emulsifier, a dispersing agent, a stabilizer, a foam-moderating agent, a preservative, an anti-freeze agents, a solubility-enhancing agent, a dye or pigment, a pH modifier, a thickening agent, a fragrance, an adjuvant, an excipient, a fertilizer, a rainfast agent, or any combinations thereof.

15. The composition of claim 1, wherein the post-emergent herbicidal active agent has a concentration of about 0.01 wt% to about 20 wt% based on the total weight of the composition.

16. The composition of claim 1, wherein the residual control active agent has a concentration of about 0.001 wt% to about 10 wt% based on the total weight of the composition.

17. The composition of claim 1, wherein the burndown agent has a concentration of about 0.05 wt% to about 50 wt% based on the total weight of the composition.

18. The composition of claim 1, wherein the composition is a ready-to-use (RTU) solution.

19. The composition of claim 18, wherein the RTU solution has a concentration of the post-emergent herbicidal active agent from about 0.01 wt% to about 3 wt% based on the total weight of the RTU solution.

20. The composition of claim 18, wherein the RTU solution has a concentration of the residual control active agent from about 0.001 wt% to about 1 wt% based on the total weight of the RTU solution.

21. The composition of claim 18, wherein the RTU solution has a concentration of the burndown agent from about 0.1 wt% to about 20 wt% based on the total weight of the RTU solution.

22. The composition of claim 18, wherein the RTU solution is packaged in a spray container.

23. The composition of claim 1, wherein the composition has a form selected from a liquid, powder, tablet, granule, or dried concentrate.

24. A non-selective herbicide composition, comprising:
from about 0.01 wt% to about 20 wt% of a post-emergent herbicidal active agent selected from glufosinate or a salt or derivative thereof;
from about 0.001 wt% to about 10 wt% of a residual control active agent comprising a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof;
from about 0.05 wt% to about 50 wt% of a burndown agent comprising a fatty acid compound, or an organic dication compound such as diquat dibromide, or any combinations thereof; and
a carrier,
wherein the composition has a weight ratio of the post-emergent herbicidal active agent to the residual control active agent from about 100:1 to about 1:1,
wherein the composition has a weight ratio of the post-emergent herbicidal active agent to the burndown agent from about 5:1 to about 1:5.

25. The composition of claim 24, wherein,
the PPO inhibitor comprises flumioxazin;
the 4-HPPD inhibitor comprises topramezone; and
the ALS/ALHS inhibitor comprises at least one of imazapic, imazapyr, imazethapyr, or any combinations thereof.

26. The composition of any one of claim 24, wherein the post-emergent herbicidal active agent is glufosinate and the residual control active agent is flumioxazin, and wherein the weight ratio of glufosinate to flumioxazin is about 30:1 or less.

27. The composition of claim 24, wherein the burndown agent is selected from ammonium nonanoate, alkali nonanoate, alkaline earth nonanoate, or any combinations thereof.

28. The composition of claim 24, wherein the composition has a weight ratio of the residual control active agent to the burndown agent from about 1:1 to about 1:150.

29. A non-selective herbicide RTU composition, comprising:
from about 0.1 wt% to about 0.5 wt% of glufosinate or a salt or derivative thereof;
from about 0.01 wt% to about 0.1 wt% of flumioxazin;
from about 1 wt% to about 5 wt% of ammonium nonanoate; and
water,
wherein the composition has a weight ratio of glufosinate to flumioxazin about 24:1 or less,
wherein the composition has a weight ratio of glufosinate to ammonium nonanoate about 1:10 or less,
wherein the composition has a weight ratio of flumioxazin to ammonium nonanoate about 1:100 or less.

30. A non-selective herbicide RTU composition, comprising:
from about 0.1 wt% to about 0.5 wt% of glufosinate or a salt or derivative thereof;
from about 0.01 wt% to about 0.1 wt% of flumioxazin;
from about 1 wt% to about 5 wt% of a diquat compound; and
water,
wherein the composition has a weight ratio of glufosinate to flumioxazin about 24:1 or less,
wherein the composition has a weight ratio of glufosinate to diquat compound about 1:10 or less,
wherein the composition has a weight ratio of flumioxazin to diquat compound about 1:10 or less.

31. A non-selective herbicide RTU composition, comprising:
from about 0.1 wt% to about 0.5 wt% of glufosinate or a salt or derivative thereof;
from about 0.01 wt% to about 0.05 wt% of an ALS/ALHS inhibitor selected from imazapic, imazapyr, imazethapyr, or derivatives thereof, or any combinations thereof;
from about 1 wt% to about 5 wt% of a burndown agent selected from ammonium nonanoate, a diquat compound, or both; and
water,
wherein the composition has a weight ratio of glufosinate to the ALS/ALHS inhibitor about 10:1 or less,
wherein the composition has a weight ratio of glufosinate to the burndown agent about 1:10 or less,
wherein the composition has a weight ratio of the ALS/ALHS inhibitor to the burndown agent about 1:10 or less.

32. A non-selective herbicide RTU composition, comprising:
from about 0.1 wt% to about 0.5 wt% of glufosinate or a salt or derivative thereof;
from about 0.01 wt% to about 0.05 wt% of topramezone;
from about 1 wt% to about 5 wt% of a burndown agent selected from ammonium nonanoate, a diquat compound, or both; and
water,
wherein the composition has a weight ratio of glufosinate to topramezone about 10:1 or less,
wherein the composition has a weight ratio of glufosinate to the burndown agent about 1:10 or less,
wherein the composition has a weight ratio of topramezone to the burndown agent about 1:10 or less.

33. A method for control of annual and perennial grass and broadleaf weeds, comprising applying a non-selective herbicide composition to an area in need thereof, the non-selective herbicide composition comprising:
a post-emergent herbicidal active agent;
a residual control active agent; and
a burndown agent.

34. The method of claim 33, further comprising:
applying a maintenance composition, the maintenance composition comprising a herbicidally active agent selected from a post-emergent herbicidal active agent, a residual control active agent, a burndown agent, or any combinations thereof.

35. The method of claim 33, wherein the post-emergent herbicidal active agent comprises glufosinate or a salt or derivative thereof.

36. The method of claim 33, wherein the residual control active agent comprises at least one of a protoporphyrinogen oxidase (PPO) inhibitor, a 4-hydroxyphenylpyruvate dioxygenase (HPPD) inhibitor, an acetolactate synthase/acetohydroxy acid synthase (ALS/AHAS) inhibitor, or any combinations thereof.

37. The method of claim 34, wherein the maintenance composition is applied at least 15 days after applying the non-selective herbicide composition.

38. The method of claim 33, wherein applying the non-selective herbicide composition comprises spraying the non-selective herbicide composition stored in a spray container to the area.

39. The method of claim 33, wherein the non-selective herbicide composition has rainfast property after application.

40. The method of claim 33, wherein applying a non-selective herbicide composition causes early burndown symptoms of weeds or undesired plants after about 30 minutes to about 6 hours.

41. The method of claim 33, wherein applying a non-selective herbicide composition causes long-term control efficacy and remains effective for at least 15 days.

42. The method of claim 33, wherein the area is a landscape edge, a non-crop area around farmsteads, building foundation, a shelter belt, a fencerow, a driveway, a sidewalk, a paver patio, a gravel area, an area under deck, a parking area, a walkway, and any unplanted area where no weeds are desired.

43. The method of claim 33, wherein the non-selective herbicide composition is effective to control a weed or grass selected from common annual broadleaf weeds, common perennial broadleaf weeds, common annual grasses, common perennial grasses, or any combinations thereof.
